(19) United States
(12) Patent Application Publication
(10) Pub. No.: US 2026/0134587 A1
(43) Pub. Date: May 14, 2026

(54) DISPLAY CONTROL DEVICE, VIDEO DISPLAY SYSTEM, AND DISPLAY CONTROL METHOD

(71) Applicant: Panasonic Automotive Systems Co., Ltd., Kanagawa (JP)

(72) Inventors: Tomoka ISHIBASHI, Osaka (JP); Yukiko ITO, Kyoto (JP); Masaya TSUDA, Osaka (JP); Mikio YAGI, Osaka (JP); Yu NAKASHIMA, Kanagawa (JP)

(73) Assignee: Panasonic Automotive Systems Co., Ltd., Kanagawa (JP)

(21) Appl. No.: 19/381,433

(22) Filed: Nov. 6, 2025

(30) Foreign Application Priority Data
Nov. 11, 2024 (JP) 2024-196800
Mar. 31, 2025 (JP) 2025-058236

(51) Int. Cl. G06T 11/00; B60K 35/29

(52) U.S. Cl. CPC G06T 11/00; B60K 35/29; B60K 2360/186; G06T 2210/62

(57) ABSTRACT

A display control device controls display on a display provided in a vehicle, and the display control device includes a controller that controls display in a first display region on the display and display in a second display region on the display, the first display region being smaller than a maximum display region on the display, the second display region being different from the first display region. The controller causes a video to be displayed in the first display region, and causes a blurred video in which a part of the video is blurred to be displayed in the second display region.

### CROSS REFERENCE TO RELATED APPLICATIONS

The present application is based on and claims priority of Japanese Patent Application No. 2024-196800 filed on Nov. 11, 2024, and Japanese Patent Application No. 2025-058236 filed on Mar. 31, 2025.

### Field

The present disclosure relates to a display control device which controls display on a display, a video display system which includes a display and a display control device, and a display control method.

### BACKGROUND

Conventionally, a display control device is known which controls display on a display provided in a vehicle. Patent Literature 1 discloses an information processing device which changes, based on vibration information of a vehicle, parameters of presentation information presented inside the vehicle. In the information processing device, for example, the following processing is performed when vibration occurs: blurring is applied to a video displayed on a display, the brightness of the video is reduced, the transparency of the video is changed, and the area of the video displayed on the display is reduced.

### CITATION LIST

### Patent Literature

PTL 1: International Publication No. 2021/166801

### SUMMARY

However, the device according to PTL 1 can be improved upon.

In view of this, the present disclosure provides a display control device and the like capable of improving upon the above related art.

A display control device according to one aspect of the present disclosure is a display control device that controls display on a display provided in a vehicle, the display control device includes: a controller that controls display in a first display region on the display and display in a second display region on the display, the first display region being smaller than a maximum display region on the display, the second display region being different from the first display region, and the controller causes a video to be displayed in the first display region, and causes a blurred video in which a part of the video is blurred to be displayed in the second display region.

A video display system according to one aspect of the present disclosure includes: the display provided in the vehicle; and the display control device described above.

A display control method according to one aspect of the present disclosure is a display control method for controlling display on a display provided in a vehicle, and the display control method includes: when performing display in a first display region and a second region on the display, displaying a video in the first display region and a blurred video in which a part of the video is blurred in the second display region, the first display region being smaller than a maximum display region on the display, the second display region being different from the first display region.

These general or specific aspects may be realized by a system, a method, an integrated circuit, a computer program, or a computer-readable recording medium such as a CD-ROM, or may be realized by any combination of a system, a method, an integrated circuit, a computer program, and a recording medium. The recording medium may be a non-transitory recording medium.

A display control device or the like according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing a vehicle and a display provided in the vehicle.

FIG. 2 is a diagram when a video displayed on the display is viewed from the rear seat of the vehicle.

FIG. 3 is a diagram showing an example where the video on the display is reduced in size and displayed.

FIG. 4 is a block configuration diagram showing a display control device and a display included in a video display system in Embodiment 1.

FIG. 5 is a diagram showing an example of a video displayed in a first display region on the display and a blurred video displayed in a second display region.

FIG. 6 is a diagram showing an example of generation of the blurred videos displayed in the second display regions.

FIG. 7 is a diagram showing another example of generation of the blurred videos displayed in the second display regions.

FIG. 8 is a diagram schematically showing the video displayed in the first display region and the blurred videos displayed in the second display regions in FIG. 5.

FIG. 9 is a diagram schematically showing a video displayed in a first display region and blurred videos displayed in second display regions in Variation 1 of Embodiment 1.

FIG. 10 is a diagram schematically showing a video displayed in a first display region and a blurred video displayed in a second display region in Variation 2 of Embodiment 1.

FIG. 11 is a diagram schematically showing a video displayed in a first display region and blurred videos displayed in second display regions in Variation 3 of Embodiment 1.

FIG. 12 is a diagram schematically showing a video displayed in a first display region and a blurred video displayed in a second display region in Variation 4 of Embodiment 1.

FIG. 13 is a block configuration diagram showing a display control device and a display included in a video display system in Embodiment 2.

FIG. 14 is a diagram when a video displayed on the display in Embodiment 2 and the like are viewed from a rear seat.

FIG. 15 is a block configuration diagram showing a display control device and a display included in a video display system in Embodiment 3.

FIG. 16 is a block diagram showing the configuration of a video control system in Embodiment 4.

FIG. 17 is a diagram showing a vehicle and a display provided in the vehicle.

FIG. 18 is a diagram when the display is viewed from the rear seat of the vehicle.

FIG. 19 is a flowchart showing an operation of fatigue recovery support performed by the video control system in Embodiment 4.

FIG. 20A is a diagram showing a first example of video content.

FIG. 20B is a diagram showing a second example of the video content.

FIG. 20C is a diagram showing a third example of the video content.

FIG. 20D is a diagram showing a fourth example of the video content.

FIG. 21 is a flowchart showing an operation performed by the video control system in Embodiment 4 in a second awakening phase shown in FIG. 19.

FIG. 22 is a diagram showing an example of a notification displayed on the display.

### DESCRIPTION OF EMBODIMENTS

### Circumstances Leading to the Present Disclosure

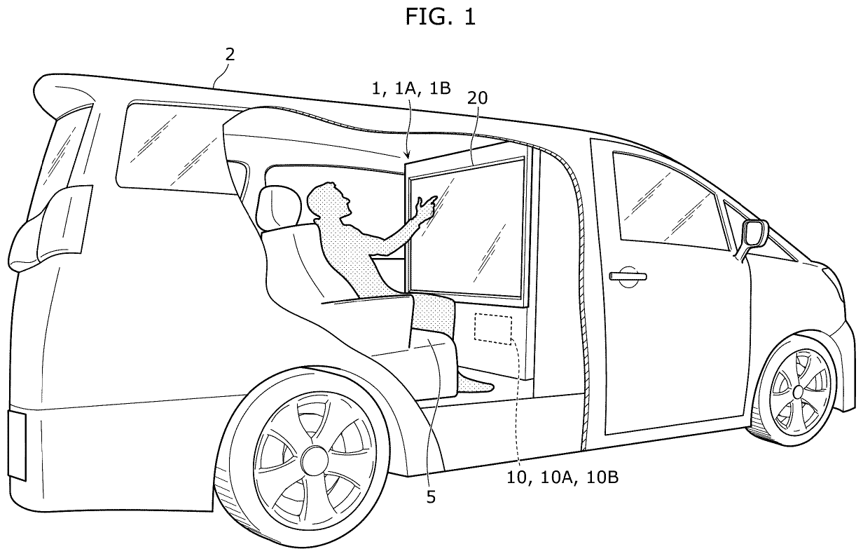

Circumstances leading to the present disclosure will be described with reference to FIGS. 1 to 3.

FIG. 1 is a diagram showing vehicle 2 and display 20 provided in vehicle 2.

For example, a video or the like is displayed on display 20 in vehicle 2, and thus it is possible to create a comfortable space in vehicle 2.

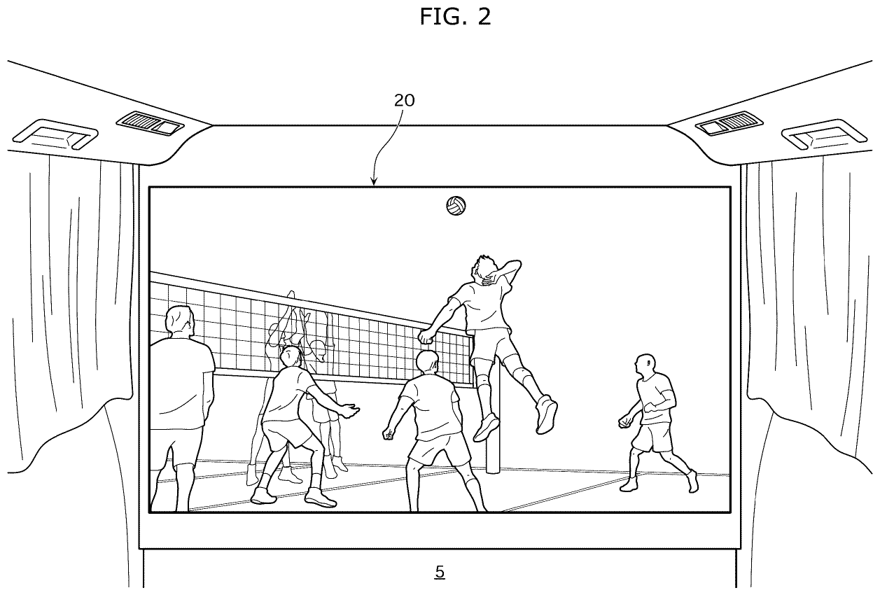

FIG. 2 is a diagram when a video displayed on display 20 is viewed from rear seat 5 of vehicle 2.

FIG. 2 shows an example where display 20 is used to display a video of sports broadcast. However, as shown in FIG. 2, if the video displayed on display 20 is excessively large, the movement of eyes, the turning of a head, or the like in response to the movement of the video is large, and thus a person viewing the video may become car sick (motion sickness). Hence, it is conceivable that the area of the video displayed on display 20 is reduced, thus the movement of the eyes and the turning of the head are decreased, and consequently, car sickness can be suppressed.

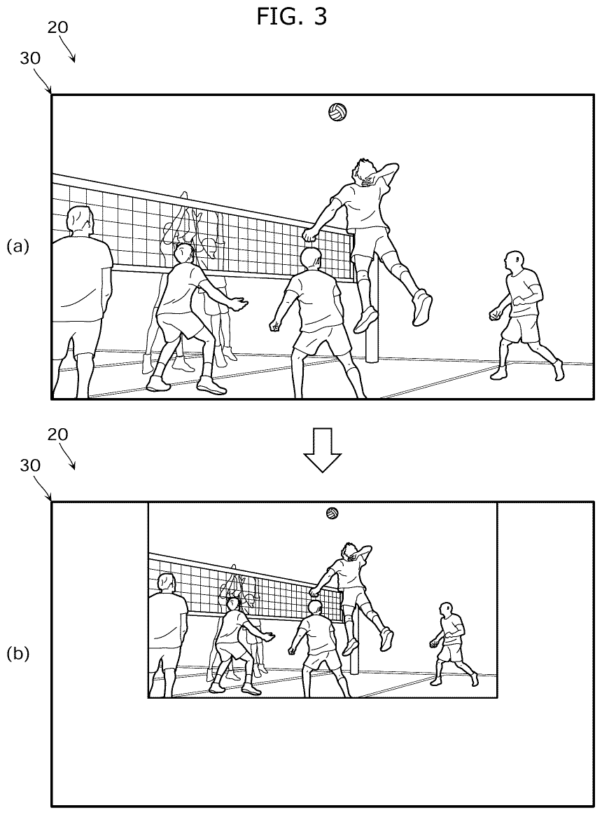

FIG. 3 is a diagram showing an example where the video on display 20 is reduced in size and displayed.

In part (a) in FIG. 3, the video is displayed in maximum display region 30 on display 20. Maximum display region 30 is the maximum region in which the video can be displayed on display 20. Specifically, maximum display region 30 is a region which is formed in the shape of a horizontally long rectangle, and corresponds to the full-inch size of display 20.

In part (b) in FIG. 3, the video shown in part (a) is reduced in size, and the video is displayed in a region smaller than maximum display region 30. For example, the area of the region in which the video is displayed is about one-fourth of the area of maximum display region 30. The remaining region other than the region in which the video is displayed is a non-display region in which no video is displayed, and has substantially the same color and brightness as when the power is off.

As shown in FIG. 3, the video displayed on display 20 is reduced in size, and thus it is possible to suppress the car sickness of a passenger. However, when the area of the video displayed is decreased, and thus the movement of the video is decreased, with the result that immersion in the video is disadvantageously lowered.

Although in a conventional technique, parameters for the brightness, the blurring, and the transparency of the video are changed, when the brightness, the blurring, the transparency of the video are changed, the amount of information of the original video may be lost.

By contrast, a display control device in the present disclosure has the following configuration in order to suppress the loss of the amount of information of the original video and a decrease in immersion in the video.

Embodiments will be specifically described below with reference to drawings. The embodiments described below indicate specific examples of the present disclosure. Numerical values, shapes, materials, constituent elements, the arrangement and connection of the constituent elements, and the like shown in the following embodiments are examples, and are not intended to limit the present disclosure. Among the constituent elements in the following embodiments, constituent elements which are not recited in the independent claims are described as optional constituent elements.

The drawings are schematic views, and are not exactly shown. In the drawings, substantially the same configurations are identified with the same reference signs, and repeated description is omitted or simplified. In the present embodiment, a horizontal direction in the display may be referred to as a lateral direction, and a vertical direction may be referred to as a longitudinal direction.

### Embodiment 1

### Configurations of Video Display System and Display Control Device

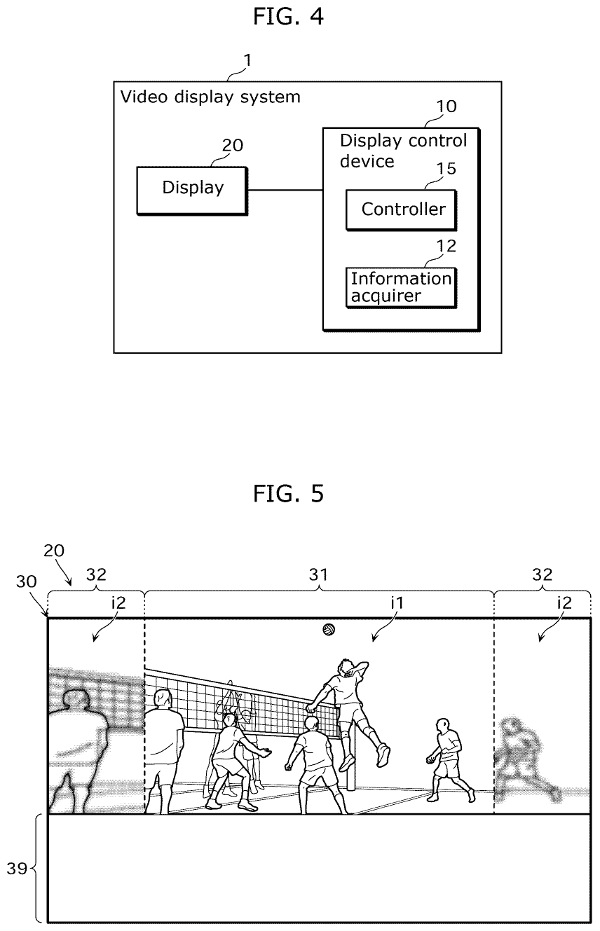

The configurations of a video display system and a display control device according to Embodiment 1 will be described with reference to FIGS. 4 to 8.

FIG. 4 is a block configuration diagram showing display control device 10 and display 20 included in video display system 1 in Embodiment 1.

Video display system 1 is a system which displays a video, and is utilized, for example, when television is watched, a business meeting is conducted, or tourist information is provided.

As shown in FIG. 4, video display system 1 includes display control device 10 and display 20.

Display 20 is, for example, a liquid crystal display or an organic electro luminescence (EL) display. Display 20 is provided between the front seat and rear seat 5 in vehicle 2. Display 20 is disposed along the vertical direction such that a display surface is directed to rear seat 5, and a rear surface is directed to the front seat. The size of display 20 is, for example, greater than or equal to 40 inches and less than or equal to 60 inches.

Display control device 10 is a device which controls display of display 20 provided in vehicle 2. Although FIG. 4 shows an example where display 20 and display control device 10 are different constituent elements, the present disclosure is not limited to this example, and display control device 10 may be incorporated into the housing of display 20. Display control device 10 may be formed with a part of an electronic control unit (ECU) in vehicle 2.

Display control device 10 includes a first mode and a second mode which are examples of the operation mode of display control device 10. The first mode is a mode where a video is displayed in maximum display region 30 which is the entire surface of display 20, and the second mode is a mode where a video is displayed in a region smaller than maximum display region 30. The first mode and the second mode can be switched by a mode switching signal which is output from the ECU.

As shown in FIG. 4, display control device 10 includes controller 15 and information acquirer 12.

Information acquirer 12 acquires video content transmitted by video distribution. Information acquirer 12 may acquire video content from a recording medium such as a digital versatile disc (DVD), a Blu-ray (registered trademark) disc (BD), or a hard disk.

Information acquirer 12 acquires the mode switching signal output from the ECU, and outputs the mode switching signal to controller 15. When the mode switching signal is transmitted from an external remote controller (not shown), information acquirer 12 may acquire the mode switching signal transmitted from the remote controller, and output the mode switching signal to controller 15.

Controller 15 switches between the first mode and the second mode based on the mode switching signal. In the present embodiment, a video is displayed in a region smaller than maximum display region 30 so that the car sickness of the passenger is suppressed. Hence, the second mode in which a video is displayed in a region smaller than maximum display region 30 will be mainly described below.

FIG. 5 is a diagram showing an example of video i1 displayed in first display region 31 on display 20 and blurred video i2 displayed in second display region 32.

As shown in FIG. 5, controller 15 forms first display region 31 and second display region 32 on display 20, and causes a video to be displayed in each of first display region 31 and second display region 32.

First display region 31 is smaller than maximum display region 30 on display 20. The size of first display region 31 is, for example, greater than or equal to the one-fourth of maximum display region 30 and less than or equal to the half thereof. First display region 31 is formed in the shape of a horizontally long rectangle, and the aspect ratio of first display region 31 is the same as the aspect ratio of maximum display region 30. First display region 31 is disposed such that its upper long side is in contact with the upper long side of maximum display region 30, and is disposed in the center of maximum display region 30 in the lateral direction.

Based on the video content acquired by information acquirer 12, controller 15 causes a video corresponding to the size of first display region 31 to be displayed in first display region 31. If a video is displayed in maximum display region 30, the video displayed in first display region 31 is obtained by reducing the size of the video displayed in maximum display region 30. In other words, controller 15 causes the video obtained by reducing the size of the video in maximum display region 30 to be displayed in first display region 31. As described above, video i1 is displayed in first display region 31 smaller than maximum display region 30, and thus it is possible to suppress the car sickness of the passenger.

If a video is displayed in maximum display region 30, controller 15 causes a video to be displayed in first display region 31 such that the amount of information of the video displayed in first display region 31 is not reduced as compared with the amount of information of the video displayed in maximum display region 30. For example, controller 15 causes the video to be displayed in first display region 31 such that parameters for the brightness, the blurring, the transparency, and the like of the video displayed in maximum display region 30 are the same as parameters for the brightness, the blurring, the transparency, and the like of the video displayed in maximum display region 30, that is, parameters are not changed. In this way, it is possible to suppress the loss of the amount of information of the original video.

Second display region 32 is a region which is different from first display region 31. In this example, two second display regions 32 are formed on display 20. Two second display regions 32 are located on the left side and the right side of first display region 31. Second display region 32 is formed in the shape of a longitudinally long rectangle, and is disposed adjacent to first display region 31. The length of second display region 32 in the lateral direction is shorter than the length of first display region 31 in the lateral direction, and the length of second display region 32 in the longitudinal direction is the same as the length of first display region 31 in the longitudinal direction.

Controller 15 in this example does not form second display region 32 on the upper side and the lower side of first display region 31, and forms second display regions 32 in regions on sides other than the upper side and the lower side of first display region 31. In FIG. 5, a region on the lower side of first display region 31 and regions on the lower side of second display regions 32 are non-display region 39 in which no video is displayed, and non-display region 39 has substantially the same color and brightness as when the power is off.

Controller 15 in the present embodiment causes video i1 to be displayed in first display region 31, and causes blurred videos i2 in which parts of video i1 are blurred to be displayed in second display regions 32.

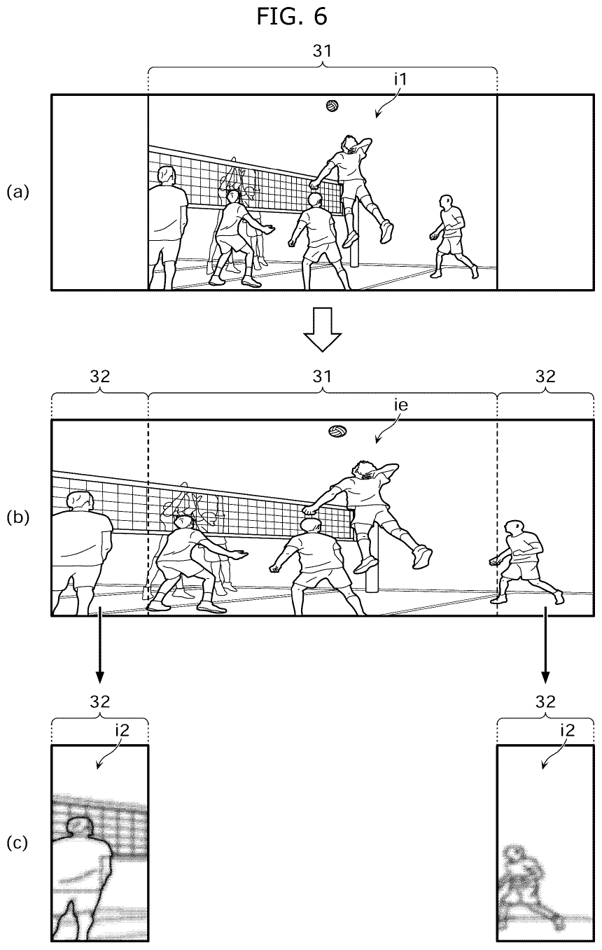

FIG. 6 is a diagram showing an example of generation of blurred videos i2 displayed in second display regions 32. FIG. 6 is a diagram for illustrating internal processing in display control device 10, and does not show videos which are displayed on actual display 20.

Controller 15 generates extended video ie by extending, as shown in part (b), video i1 displayed in first display region 31 in part (a) in FIG. 6 into second display regions 32. For example, controller 15 generates extended video ie by extending video i1 displayed in first display region 31 in the lateral direction such that the length of video i1 in the lateral direction matches the total length of first display region 31 and two second display regions 32 in the lateral direction.

As shown in part (c) in FIG. 6, controller 15 generates two blurred videos i2 by blurring parts of extended video ie in regions overlapping two second display regions 32. Blurred images used for generating blurred videos i2 are formed by smoothing images using, for example, a Gaussian filter. The degree of blurring can be increased by increasing the degree of smoothing of the images.

Controller 15 disposes blurred video i2 on the left side of two blurred videos i2 in second display region 32 on the left side of first display region 31, and disposes blurred video i2 on the right side in second display region 32 on the right side of first display region 31. In this way, as shown in FIG. 5, controller 15 causes blurred videos i2 in which parts of video i1 are blurred to be displayed in second display regions 32.

Although in FIG. 5, dashed lines are shown between first display region 31 and second display regions 32, there are actually no boundary lines such as the dashed lines, and boundaries are present between the region which is not smoothed and the regions which are smoothed.

As described above, video i1 is displayed in first display region 31, and blurred videos i2 in which the parts of video i1 are blurred are displayed in second display region 32, and thus in second display regions 32, the movement of the video related to first display region 31 can be added. In this way, it is possible to suppress the loss of the amount of information of the original video and a decrease in immersion in the video.

Although the example where video i1 is extended and then blurred videos i2 are generated has been described above, the present disclosure is not limited to this example. For example, the video in part (a) in FIG. 6 is blurred, thus the blurred video is generated, and then the blurred video is extended in the lateral direction, with the result that extended video ie may be generated as shown in part (b).

Controller 15 may generate blurred videos i2 without extending video i1.

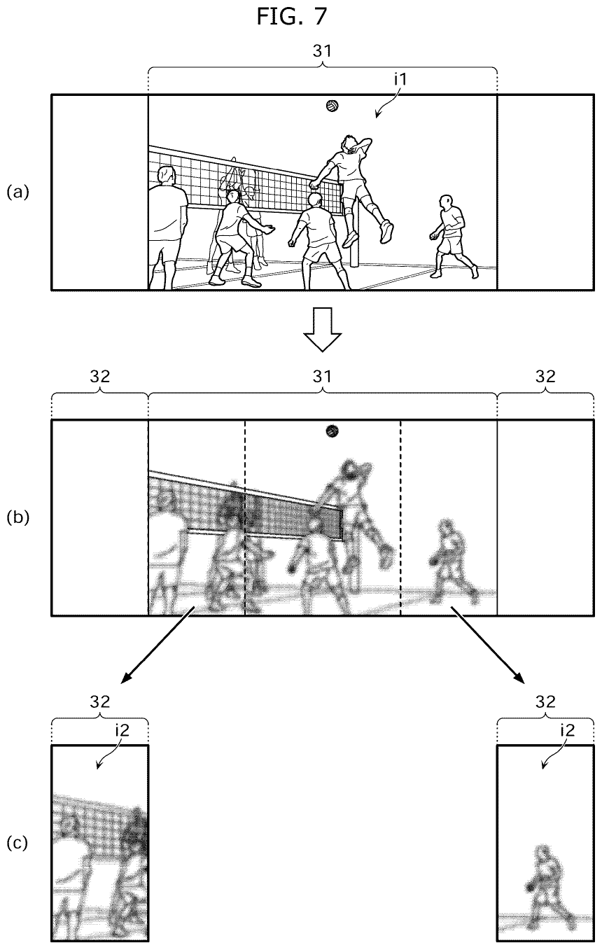

FIG. 7 is a diagram showing another example of generation of blurred videos i2 displayed in second display regions 32. FIG. 7 is also a diagram for illustrating internal processing in display control device 10, and does not show videos which are displayed on actual display 20.

Controller 15 generates blurred videos by blurring, as shown in part (b), video i1 displayed in first display region 31 in part (a) in FIG. 7. Controller 15 extracts, as shown in part (c) in FIG. 7, blurred videos i2 of the blurred video generated in part (b) in regions corresponding to the width of second display region 32. Controller 15 disposes blurred video i2 on the left side of the blurred video generated in part (b) in FIG. 7 in second display region 32 on the left side of first display region 31, and disposes blurred video i2 on the right side in second display region 32 on the right side of first display region 31. In this way, controller 15 causes blurred videos i2 in which parts of video i1 are blurred to be displayed in second display regions 32. In the example of generation of blurred videos i2 shown in FIG. 7, the same effects as in the example shown in FIG. 6 can be achieved.

Although the examples where blurred videos i2 are displayed in second display regions 32 have been described above, controller 15 may further increase the degree of blurring of blurred videos i2 in order to reduce the movement of blurred videos i2 in second display regions 32. Controller 15 may also reduce a sampling rate (for example, the number of images per second) in second display region 32 in order to reduce the movement of blurred videos i2 in second display regions 32. The movement of blurred videos i2 is reduced as described above, and thus it is possible to suppress the directing of a gaze toward second display regions 32, and to reduce the likelihood of being car sick.

In the following description, video i1 in first display region 31 and blurred videos i2 in second display regions 32 are schematically shown.

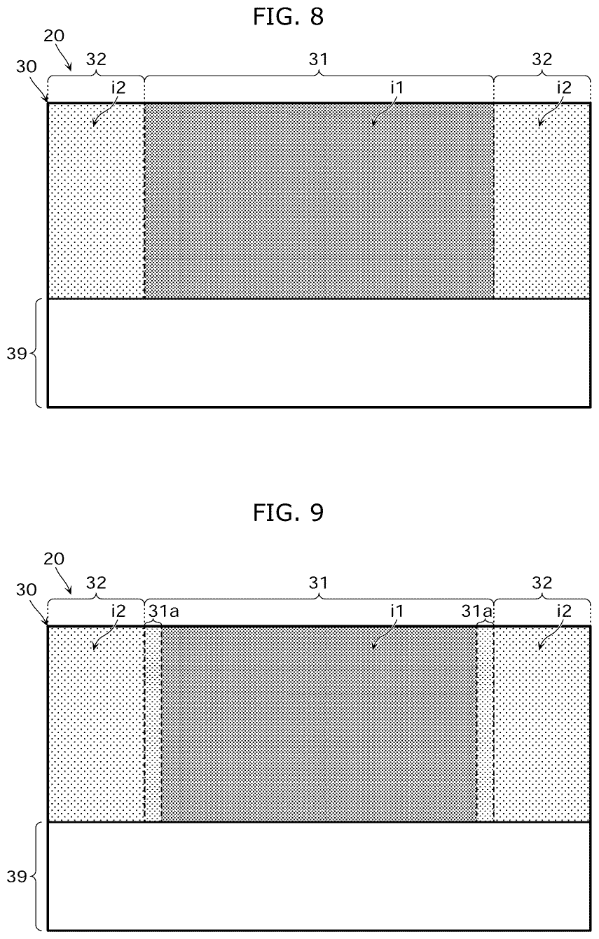

FIG. 8 is a diagram schematically showing video i1 displayed in first display region 31 and blurred videos i2 displayed in second display regions 32 in FIG. 5.

In FIG. 8, video i1 displayed in first display region 31 is indicated by dense hatching dots, and blurred videos i2 displayed in second display regions 32 are indicated by sparse hatching dots. As shown in FIG. 8, controller 15 causes video i1 to be displayed in first display region 31, and causes blurred videos i2 in which parts of video i1 are blurred to be displayed in second display regions 32. Variations of Embodiment 1 and the like will be described below with reference to schematic views.

### Variation 1 of Embodiment 1

Display control device 10 and the like according to Variation 1 of Embodiment 1 will be described. In Variation 1, an example where boundaries between first display region 31 and second display regions 32 are caused to be less noticeable will be described.

Display control device 10 in Variation 1 includes controller 15 and information acquirer 12.

FIG. 9 is a diagram schematically showing video i1 displayed in first display region 31 and blurred videos i2 displayed in second display regions 32 in Variation 1.

Controller 15 in Variation 1 causes parts of the video displayed in first display region 31 to be blurred and displayed, and the parts are in adjacent regions 31a which are adjacent to second display regions 32 and have a predetermined width.

As shown in FIG. 9, adjacent regions 31a are formed in first display region 31. In this example, adjacent regions 31a are formed at both end portions of first display region 31 in the lateral direction. Each of adjacent regions 31a has the predetermined width. The predetermined width is the length of adjacent region 31a in the lateral direction, and is sufficiently shorter than the length of first display region 31 in the lateral direction. The predetermined width is, for example, the length which corresponds to five pixels or more and ten pixels or less among a plurality of pixels of display 20. The length of adjacent region 31a in the longitudinal direction is the same as the length of first display region 31 in the longitudinal direction.

For example, controller 15 increases the degree of blurring in adjacent regions 31a in order to blur parts of the video in adjacent regions 31a. The degree of blurring in adjacent regions 31a is provided by smoothing images using, for example, the Gaussian filter. In this way, the videos are blurred to be smoothed, and thus distinction between the surrounding pixels and adjacent regions 31a is reduced, with the result that the boundaries can be less noticeable.

The degree of blurring in adjacent regions 31a is between the degree of blurring in first display region 31 (for example, the degree of blurring is zero) and the degree of blurring in second display regions 32. In other words, the degree of blurring generated in adjacent regions 31a is higher than the degree of blurring around the center of first display region 31, and is less than the degree of blurring in second display regions 32. Controller 15 may gradually increase the degree of blurring along a direction extending outward from inside first display region 31 so that the degree of blurring is changed inside adjacent region 31a.

In this way, the parts of the video in adjacent regions 31a which are adjacent to second display region 32 and have the predetermined width are blurred and displayed, and thus the boundaries between first display region 31 and second display regions 32 can be less noticeable. The boundaries are caused to be less noticeable, and thus it is possible to reduce an uncomfortable feeling, to suppress the directing of a gaze toward the boundaries, and to reduce the likelihood of being car sick.

### Variation 2 of Embodiment 1

Display control device 10 and the like according to Variation 2 of Embodiment 1 will be described. In Variation 2, an example where second display region 32 is formed on one of the left side and the right side of first display region 31 will be described.

Display control device 10 in Variation 2 includes controller 15 and information acquirer 12.

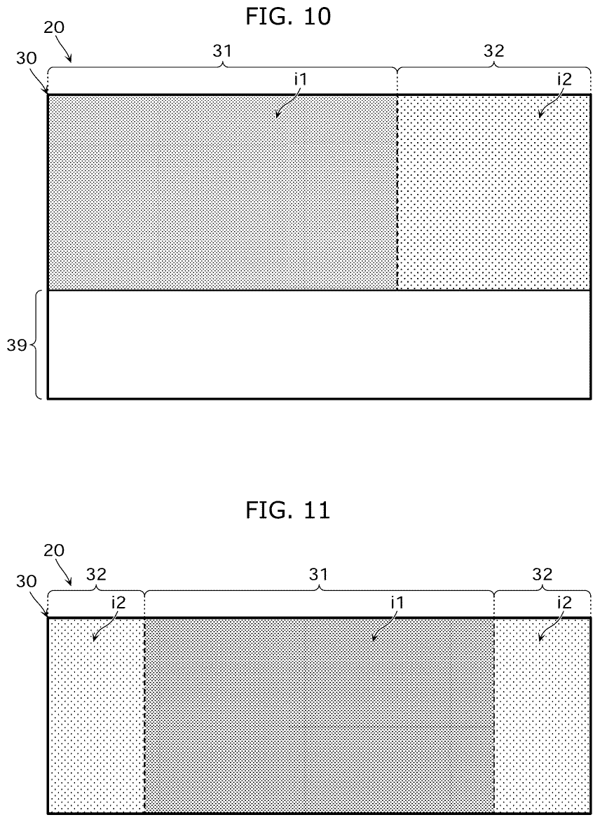

FIG. 10 is a diagram schematically showing video i1 displayed in first display region 31 and blurred video i2 displayed in second display regions 32 in Variation 2.

Controller 15 in Variation 2 causes blurred video i2 to be displayed in second display region 32 located on the left side or the right side of first display region 31.

Second display region 32 shown in FIG. 10 is located on the right side of first display region 31. Second display region 32 is formed in the shape of a longitudinally or laterally long rectangle, and is disposed adjacent to first display region 31. The length of second display region 32 in the lateral direction is shorter than the length of first display region 31 in the lateral direction, and the length of second display region 32 in the longitudinal direction is the same as the length of first display region 31 in the longitudinal direction.

For example, when a person who is not prone to car sickness sits on the left side of rear seat 5, and a person who is prone to car sickness sits on the right side, controller 15 may set the left side of maximum display region 30 to first display region 31, and cause video i1 to be displayed in first display region 31, and set the right side to second display region 32, and cause blurred video i2 to be displayed in second display region 32. When a person who is prone to car sickness sits on the left side of rear seat 5, and a person who is not prone to car sickness sits on the right side, controller 15 may set the left side of maximum display region 30 to second display region 32, and cause blurred video i2 to be displayed in second display region 32, and set the right side to first display region 31, and cause video i1 to be displayed in first display region 31.

Information acquirer 12 may acquire, from an external remote controller, passenger information as to whether a person who is prone to car sickness sits, and output the passenger information to controller 15. Controller 15 may control the location of first display region 31 and second display region 32 based on the passenger information acquired by information acquirer 12.

As described above, blurred video i2 is displayed in second display region 32 located on the left side or the right side of first display region 31, and thus it is possible to suppress the car sickness of the passenger. For a person who is viewing video i1, it is possible to suppress the loss of the amount of information of the original video and a decrease in immersion in the video.

### Variation 3 of Embodiment 1

Display control device 10 and the like according to Variation 3 of Embodiment 1 will be described. In Variation 3, an example where non-display region 39 is not present on display 20, and maximum display region 30 is formed with only first display region 31 and second display regions 32 will be described.

Display control device 10 in Variation 3 includes controller 15 and information acquirer 12.

FIG. 11 is a diagram schematically showing video i1 displayed in first display region 31 and blurred videos i2 displayed in second display regions 32 in Variation 3.

The configuration of first display region 31 and second display regions 32 is substantially the same as in Embodiment 1. In this example, non-display region 39 is not present on display 20, and maximum display region 30 is formed with display regions such as first display region 31 and second display region 32. The display region refers to the region in which a video is displayed by control of controller 15.

Controller 15 causes a video to be displayed in first display region 31, and causes blurred videos i2 in which parts of the video are blurred to be displaced in second display regions 32. Specifically, controller 15 causes blurred videos i2 to be displayed in two second display regions 32 located on the left side and the right side of first display region 31.

As described above, video i1 is displayed in first display region 31, and blurred videos i2 in which the parts of video i1 are blurred are displayed in second display region 32, and thus in second display regions 32, the movement of the video related to first display region 31 can be added. In this way, it is possible to suppress the loss of the amount of information of the original video and a decrease in immersion in the video.

### Variation 4 of Embodiment 1

Display control device 10 and the like according to Variation 4 of Embodiment 1 will be described. In Variation 4, an example where second display region 32 is also formed on the lower side of first display region 31 will be described.

Display control device 10 in Variation 4 includes controller 15 and information acquirer 12.

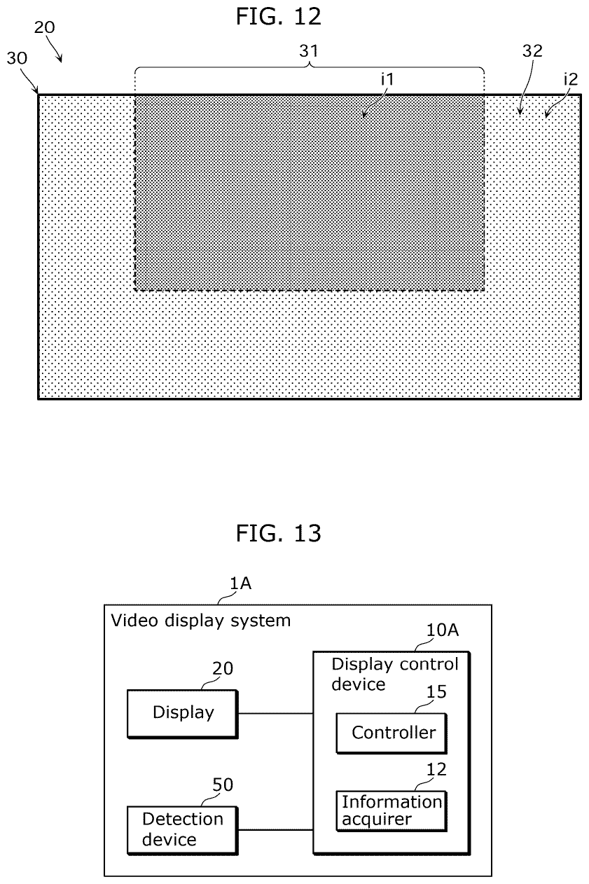

FIG. 12 is a diagram schematically showing video i1 displayed in first display region 31 and blurred video i2 displayed in second display region 32 in Variation 4.

The configuration of first display region 31 is substantially the same as in Embodiment 1.

Controller 15 in Variation 4 causes blurred video i2 to be displayed in second display region 32 located on the left side, the right side, and the lower side of first display region 31. As described above, blurred video i2 is displayed in second display region 32 which is different from first display region 31, and thus it is possible to suppress the loss of the amount of information of the original video and a decrease in immersion in the video.

Although the example where second display region 32 is formed on the lower side of first display region 31 has been described above, the present disclosure is not limited to this example. For example, controller 15 may cause blurred video i2 to be displayed in second display region 32 located on the left side, the right side, and the upper side of first display region 31. Controller 15 may cause blurred video i2 to be displayed in second display region 32 located on the left side, the right side, the upper side, and the lower side of first display region 31. In other words, controller 15 may cause blurred video i2 to be displayed in second display region 32 located around first display region 31. As described above, blurred video i2 is displayed in second display region 32 which is different from first display region 31, and thus it is possible to suppress the loss of the amount of information of the original video and a decrease in immersion in the video.

### Embodiment 2

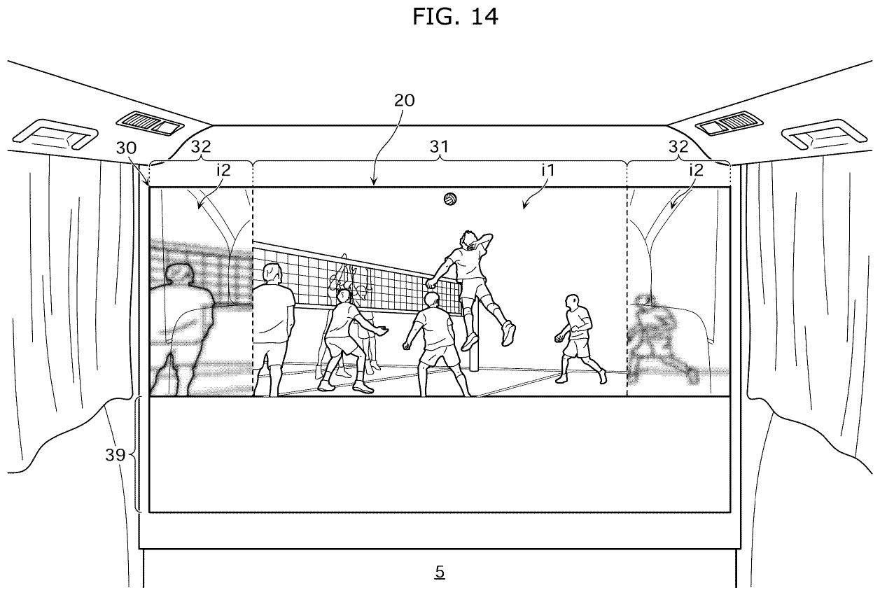

The configuration of video display system 1A and display control device 10A according to Embodiment 2 will be described with reference to FIGS. 13 and 14. In Embodiment 2, an example will be described where display 20 is a translucent display, and the state of the interior of vehicle 2 on the side of the rear surface of second display region 32 and the like are seen through.

FIG. 13 is a block configuration diagram showing display control device 10A and display 20 included in video display system 1A in Embodiment 2.

As shown in FIG. 13, video display system 1A includes display control device 10A and display 20. Video display system 1A also includes detection device 50 which detects conditions inside and outside vehicle 2.

Display 20 in Embodiment 2 is, for example, a translucent display which allows the rear side of display 20 to be seen. Display 20 is provided between the front seat and rear seat 5 in vehicle 2. Display 20 is disposed along the vertical direction such that a display surface is directed to rear seat 5, and the rear surface is directed to the front seat. The size of display 20 is, for example, greater than or equal to 40 inches and less than or equal to 60 inches.

Display control device 10A is a device which controls display of display 20 provided in vehicle 2. Although FIG. 13 shows an example where display 20 and display control device 10A are different constituent elements, the present disclosure is not limited to this example, and display control device 10A may be incorporated into the housing of display 20. Display control device 10A may be formed with a part of an ECU in vehicle 2.

Display control device 10 includes a first mode and a second mode which are examples of the operation mode of display control device 10. The first mode is a mode in which a video is displayed in maximum display region 30 which is the entire surface of display 20, and the second mode is a mode in which a video is displayed in a region smaller than maximum display region 30. The first mode and the second mode can be switched by a mode switching signal which is output from the ECU.

As shown in FIG. 13, display control device 10A includes controller 15 and information acquirer 12.

Information acquirer 12 acquires video content transmitted by video distribution. Information acquirer 12 may acquire video content from a recording medium such as a DVD, a Blu-ray (registered trademark) disc (BD), or a hard disk. Information acquirer 12 can acquire various types of information detected by detection device 50. The information detected by detection device 50 will be described later.

Information acquirer 12 acquires the mode switching signal output from the ECU, and outputs the mode switching signal to controller 15. When the mode switching signal is transmitted from an external remote controller, information acquirer 12 may acquire the mode switching signal transmitted from the remote controller, and output the mode switching signal to controller 15.

Controller 15 switches between the first mode and the second mode based on the mode switching signal. In the present embodiment, a video is displayed in a region smaller than maximum display region 30 so that the car sickness of the passenger is suppressed. In Embodiment 2, the second mode in which a video is displayed in a region smaller than maximum display region 30 will also be mainly described below.

FIG. 14 is a diagram when a video displayed on the display in Embodiment 2 and the like are viewed from the rear seat. FIG. 14 shows an example of video i1 displayed in first display region 31 on display 20 and blurred videos i2 displayed in second display regions 32.

As shown in FIG. 14, controller 15 forms first display region 31 and second display regions 32 on display 20, and causes the videos to be displayed in first display region 31 and second display regions 32. The configuration of first display region 31 is the same as in Embodiment 1.

Second display region 32 is a region which is different from first display region 31. In this example, two second display regions 32 are formed on display 20. Two second display regions 32 are located on the left side and the right side of first display region 31. Second display region 32 is formed in the shape of a longitudinally long rectangle, and is disposed adjacent to first display region 31. The length of second display region 32 in the lateral direction is shorter than the length of first display region 31 in the lateral direction, and the length of second display region 32 in the longitudinal direction is the same as the length of first display region 31 in the longitudinal direction.

Controller 15 does not form second display region 32 on the upper side and the lower side of first display region 31, and forms second display region 32 in regions on sides other than the upper side and the lower side of first display region 31. In FIG. 14, a region on the lower side of first display region 31 and regions on the lower side of second display regions 32 are non-display region 39 in which no video is displayed.

Controller 15 in Embodiment 2 also causes video i1 to be displayed in first display region 31, and causes blurred videos i2 in which parts of video i1 are blurred to be displayed in second display regions 32. As described above, video i1 is displayed in first display region 31, and blurred videos i2 in which the parts of video i1 are blurred are displayed in second display region 32, and thus in second display regions 32, the movement of the video related to first display region 31 can be added. In this way, it is possible to suppress the loss of the amount of information of the original video and a decrease in immersion in the video.

Controller 15 in Embodiment 2 does not cause first display region 31 to be translucent, causes video i1 to be displayed, and causes second display regions 32 to be translucent while causing blurred videos i2 to be displayed in second display regions 32. Second display regions 32 are caused to be translucent, and thus a person which sits in rear seat 5 views the interior of vehicle 2 and scenery (not shown) outside the vehicle through blurred videos i2 in second display regions 32.

For example, controller 15 changes the transparency of second display region 32 by changing at least one of the contrast or the brightness of the video displayed in second display region 32. For example, controller 15 increases the transparency of second display region 32 by lowering the contrast of the video as compared with the original video, and thereby causes second display region 32 to be translucent. Controller 15 increases the transparency of second display region 32 by decreasing the brightness of the video as compared with the original video, and thereby causes second display region 32 to be translucent. As described above, second display region 32 is caused to be translucent, and thus the state of the interior of vehicle 2 on the side of the rear surface of second display region 32 and scenery outside the vehicle can be viewed. In this way, it is possible to suppress the car sickness of the passenger.

Controller 15 may uniformly increase the transparency of second display region 32 on the left side and the transparency of second display region 32 on the right side. Controller 15 may increase the transparency of second display region 32 on the left side and the transparency of second display region 32 on the right side differently. Controller 15 may increase the transparency only by a predetermined value, and may increase the transparency to a predetermined value.

Controller 15 may change the transparency according to the video displayed in second display region 32. Controller 15 may perform control such that the transparency is constantly increased when the video is displayed. Controller 15 may change the transparency depending on the time during which the video is displayed.

Controller 15 may change a target transparency according to the passenger in vehicle 2. When a plurality of passengers are present, controller 15 may change the transparency in accordance with one of the passengers.

Controller 15 may change the transparency depending on environmental information inside and outside vehicle 2. For example, the likelihood of occurrence of car sickness varies depending on brightness inside and outside vehicle 2, road conditions, how recklessly vehicle 2 is driven, the time of day (for example, a time elapsed since a meal), an odor inside vehicle 2, and the like, and thus, controller 15 may change the transparency based on the environmental information described above. The environmental information can be detected using detection device 50 provided in vehicle 2. Examples of detection device 50 include a brightness sensor, an image sensor (camera), a vibration sensor, an acceleration sensor, a time sensor, a blood glucose sensor, a gas sensor, and the like.

Controller 15 may change the transparency depending on passenger information in vehicle 2. For example, the likelihood of occurrence of car sickness varies depending on the behavior of the passenger in vehicle 2, biological information of the passenger related to sleep and stress, the age of the passenger, the resistance of the passenger to car sickness, the posture of the passenger (for example, a seat tilt angle), and the like, and thus controller 15 may change the transparency based on the passenger information described above. The passenger information described above can be detected using detection device 50 provided in vehicle 2. Examples of detection device 50 include an image sensor (camera), a biological sensor, a seat position sensor, and the like.

The environmental information and the passenger information detected using detection device 50 are output to information acquirer 12. Controller 15 acquires the environmental information and the passenger information via information acquirer 12 to control display on display 20. As described above, the transparency of second display region 32 is changed, and thus the state of the interior of vehicle 2 and scenery outside the vehicle can be viewed. In this way, it is possible to suppress the car sickness of the passenger.

### Embodiment 3

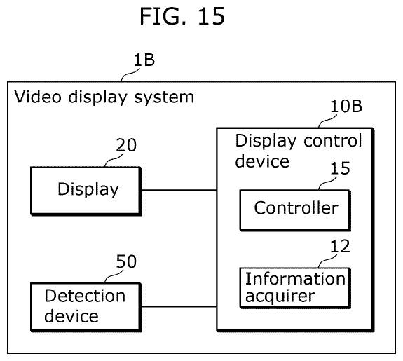

The configuration of video display system 1B and display control device 10B according to Embodiment 3 will be described with reference to FIG. 15. In Embodiment 3, an example where display 20 is not a translucent display will be described.

FIG. 15 is a block configuration diagram showing display control device 10B and display 20 included in video display system 1B in Embodiment 3.

As shown in FIG. 15, video display system 1B includes display control device 10B and display 20.

Video display system 1B includes detection device 50 which detects conditions outside the vehicle. Detection device 50 is an imaging device such as a camera, and is provided in vehicle 2.

Display 20 is, for example, a display which does not allow the rear side of display 20 to be seen. The configuration of display 20 is the same as display 20 in Embodiment 1.

Controller 15 in Embodiment 3 also causes video i1 to be displayed in first display region 31, and causes blurred videos i2 in which parts of video i1 are blurred to be displayed in second display regions 32. As described above, video i1 is displayed in first display region 31, and blurred videos i2 in which the parts of video i1 are blurred are displayed in second display region 32, and thus in second display regions 32, the movement of the video related to first display region 31 can be added. In this way, it is possible to suppress the loss of the amount of information of the original video and a decrease in immersion in the video.

Controller 15 in Embodiment 3 superimposes a video depicting information detected outside the vehicle by detection device 50 on blurred videos i2, and causes the resulting videos to be displayed in second display regions 32. As described above, the video depicting information detected outside the vehicle by detection device 50 is displayed in second display regions 32, and thus the state of the interior of vehicle 2 and scenery outside the vehicle can be viewed. In this way, it is possible to suppress the car sickness of the passenger.

### Outline of Embodiments 1 to 3

A display control device and the like according to an aspect of the present disclosure will be illustrated.

A display control device (10, 10A, and 10B) in example 1 is a display control device that controls display on display 20 provided in vehicle 2, and the display control device includes: controller 15 that controls display in first display region 31 on display 20 and display in second display region 32 on display 20, first display region 31 being smaller than maximum display region 30 on display 20, second display region 32 being different from first display region 31. Controller 15 causes video i1 to be displayed in first display region 31, and causes blurred video i2 in which a part of video i1 is blurred to be displayed in second display region 32.

As described above, video i1 is displayed in first display region 31 which is smaller than maximum display region 30, and thus it is possible to suppress the car sickness of a passenger. Blurred video i2 in which the part of video i1 is blurred is displayed in second display region 32, and thus the video related to first display region 31 can be displayed in second display region 32. In this way, it is possible to suppress the loss of the amount of information of the original video and a decrease in immersion in the video.

A display control device in example 2 is the display control device in example 1, and controller 15 may cause blurred video i2 to be displayed in second display region 32 adjacent to first display region 31.

As described above, blurred video i2 is displayed in second display region 32 adjacent to first display region 31, and thus in second display region 32 adjacent to first display region 31, the video related to first display region 31 can be displayed. In this way, it is possible to suppress the loss of the amount of information of the original video and a decrease in immersion in the video.

A display control device in example 3 is the display control device in example 2, and controller 15 may cause blurred video i2 to be displayed in two second display regions 32 each being the second display region, two second display regions 32 being located on a left side and a right side of first display region 31.

As described above, blurred video i2 is displayed in two second display regions 32 located on the left side and the right side of first display region 31, and thus in second display regions 32 on both the left and right sides of first display region 31, the video related to first display region 31 can be displayed. In this way, it is possible to suppress the loss of the amount of information of the original video and a decrease in immersion in the video.

A display control device in example 4 is the display control device in example 2, and controller 15 may cause blurred video i2 to be displayed in second display region 32 located on a left side or a right side of first display region 31.

As described above, blurred video i2 is displayed in second display region 32 located on the left side or the right side of first display region 31, and thus it is possible to suppress the car sickness of a person who sits while facing second display region 32. For a person who sits while facing first display region 31, it is possible to suppress the loss of the amount of information of the original video and a decrease in immersion in the video.

A display control device in example 5 is the display control device in any one of examples 1 to 4, and controller 15 does not need to provide second display region 32 on an upper side or a lower side of first display region 31.

In this way, the movement of the eyes of the person who sits while facing first display region 31 and the turning of the head are decreased, and thus, it is possible to suppress the car sickness of the passenger.

A display control device in example 6 is the display control device in any one of examples 2 to 4, and controller 15 may: generate extended video ie by extending video i1 displayed in first display region 31 into second display region 32; and generate blurred video i2 by blurring a part of extended video ie in a region that overlaps second display region 32.

In this way, blurred video i2 can be easily generated and displayed in second display region 32. In this way, it is possible to suppress the loss of the amount of information of the original video and a decrease in immersion in the video.

A display control device in example 7 is the display control device in any one of examples 2 to 4, and controller 15 may cause a part of the video displayed in first display region 31 to be blurred and displayed, the part being in adjacent region 31a that is adjacent to second display region 32 and has a predetermined width.

As described above, the part of the video in adjacent region 31a is blurred and displayed, and thus a boundary between first display region 31 and second display region 32 can be less noticeable. The boundary is caused to be less noticeable, and thus it is possible to reduce an uncomfortable feeling, to suppress the directing of a gaze toward the boundary, and to reduce the likelihood of being car sick.

A display control device in example 8 is the display control device in any one of examples 1 to 7, and display 20 may be a translucent display that allows a rear side of display 20 to be seen, and controller 15 may cause second display region 32 to be translucent while causing blurred video i2 to be displayed in second display region 32.

As described above, second display region 32 is caused to be translucent, and thus the state of the interior of vehicle 2 on the side of the rear surface of second display region 32 and scenery outside the vehicle can be viewed. In this way, it is possible to suppress the car sickness of the passenger.

A display control device in example 9 is the display control device in example 8, and controller 15 may change transparency of second display region 32 by changing at least one of contrast or brightness of the video (for example, blurred video i2) displayed in second display region 32.

As described above, the transparency of second display region 32 is changed, and thus the state of the interior of vehicle 2 on the side of the rear surface of second display region 32 and scenery outside the vehicle can be viewed. In this way, it is possible to suppress the car sickness of the passenger.

A display control device in example 10 is the display control device in any one of examples 1 to 7, and controller 15 may cause a video to be displayed in second display region 32, the video being obtained by superimposing, on blurred video i2, a video depicting information detected outside the vehicle by detection device 50.

As described above, the video obtained by superimposing the video depicting information detected outside the vehicle on blurred video i2 is displayed in second display region 32, and thus the state of the interior of vehicle 2 on the side of the rear surface of second display region 32 and scenery outside the vehicle can be viewed. In this way, it is possible to suppress the car sickness of the passenger.

A video display system (1, 1A, and 1B) in example 11 includes: display 20 provided in vehicle 2; and the display control device in any one of examples 1 to 10.

In this way, it is possible to provide a video display system which can suppress the car sickness of the passenger, the loss of the amount of information of the original video, and a decrease in immersion in the video.

In a display control method in example 12 for controlling display on display 20 provided in vehicle 2, when display is performed in first display region 31 on display 20 and in second display region 32 on display 20, first display region 31 is smaller than maximum display region 30 on display 20, and second display region 32 is different from first display region 31, video i1 is caused to be displayed in first display region 31, and blurred video i2 in which a part of video i1 is blurred is caused to be displayed in second display region 32.

As described above, video i1 is displayed in first display region 31 which is smaller than maximum display region 30, and thus it is possible to suppress the car sickness of the passenger. Blurred video i2 in which the part of video i1 is blurred is displayed in second display region 32, and thus the video related to first display region 31 can be displayed in second display region 32. In this way, it is possible to suppress the loss of the amount of information of the original video and a decrease in immersion in the video.

### Other Embodiments

Although the display control devices according to one or a plurality of aspects have been described above based on the above embodiments, the present disclosure is not limited to the above embodiments. Embodiments obtained by performing various types of variations conceived by those skilled in the art on the above embodiments may be included in the scope of the present disclosure without departing from the spirit of the present disclosure.

Although in Embodiment 2, the example is described where the region on the lower side of first display region 31 and the regions on the lower side of second display regions 32 are non-display region 39 in which no video is displayed, the present disclosure is not limited to this example. Controller 15 may cause non-display region 39 shown in FIG. 14 to be translucent without causing a video to be displayed in non-display region 39.

For example, in the embodiments described above, the constituent elements of a processing unit included in the display control device may be formed by dedicated hardware, or may be realized by executing software programs suitable for the constituent elements. A program executor such as a central processing unit (CPU) or a processor may read and execute software programs recorded in a non-transitory recording medium such as a hard disk or a semiconductor memory to realize the constituent elements.

The processing unit in the display control device may be realized as one processor together with the ECU and the like.

The following cases are also included in the present disclosure.
(1) At least one of the devices described above is specifically a computer system which is formed with a microprocessor, a read only memory (ROM), a random access memory (RAM), a hard disk unit, a display unit, a keyboard, a mouse, and the like. In the RAM or the hard disk unit, computer programs are stored. The microprocessor is operated according to the computer programs, and thus at least one of the devices described above achieve the functions thereof. Here, the computer programs are formed by combining a plurality of command codes for providing instructions to the computer in order to achieve predetermined functions.
(2) A part or all of the constituent elements of at least one of the devices described above may be formed with one system large scale integration (LSI) circuit. The system LSI circuit is an ultra-multifunctional LSI circuit manufactured by integrating a plurality of constituent units on one chip, and is specifically a computer system which includes a microprocessor, a ROM, a RAM, and the like. In the RAM, computer programs are stored. The microprocessor is operated according to the computer programs, and thus the system LSI circuit achieves the functions thereof.
(3) A part or all of the constituent elements of at least one of the devices described above may be formed with an IC card or a single module which is removable from the devices. The IC card or the module is a computer system which includes a microprocessor, a ROM, a RAM, and the like. The IC card or the module may include the ultra-multifunctional LSI circuit described above. The microprocessor is operated according to computer programs, and thus the IC card or the module achieves the functions thereof. The IC card or the module may be tamper-resistant.
(4) The present disclosure may be the methods described above. The present disclosure may be computer programs which cause a computer to realize these methods, or may be digital signals of computer programs.

The present disclosure may be non-transitory computer-readable recording media such as a flexible disk, a hard disk, a compact disc (CD)-ROM, a DVD, a DVD-ROM, a DVD-RAM, a Blu-ray (registered trademark) disc (BD), and a semiconductor memory in which computer programs or digital signals are recorded. The present disclosure may be the digital signals recorded in the recording media.

The present disclosure may be computer programs or digital signals which are transferred via a telecommunication line, a wireless or wired communication line, a network such as the Internet, data broadcasting, or the like.

The present disclosure may be computer programs or digital signals which are recorded in a recording medium and transferred or are transferred via a network or the like to be performed using another independent computer system.

### Embodiment 4

Conventionally, techniques for promoting human awakening have been known. A patent literature of Japanese Patent No. 7485038 discloses a sound generator which presents a call sound to a user to propose an active action in order to wake the user when the user is not awake. The sound generator described in the patent literature discloses that when the call sound for proposing the active action is presented to the user, an image indicating the active action is displayed on a display.

Incidentally, in recent years, there has been progress in the development of a vehicle which allows a user sitting in a rear seat inside the vehicle to take a temporary rest. Hence, in order to enable the user sitting in the rear seat after taking a temporary rest to awake for a short period of time, when the sound generator disclosed in patent literature 1 is applied to the vehicle, the user needs to focus on the image displayed on the display. However, the vehicle is not necessarily stopped when the user is caused to awake, and if the vehicle is traveling on a road, the user is prone to car sickness because the user gazes at the image displayed on the display, with the result that the physical condition of the user may be adversely affected.

In view of the foregoing, the inventors have come up with the present disclosure.

### Configuration

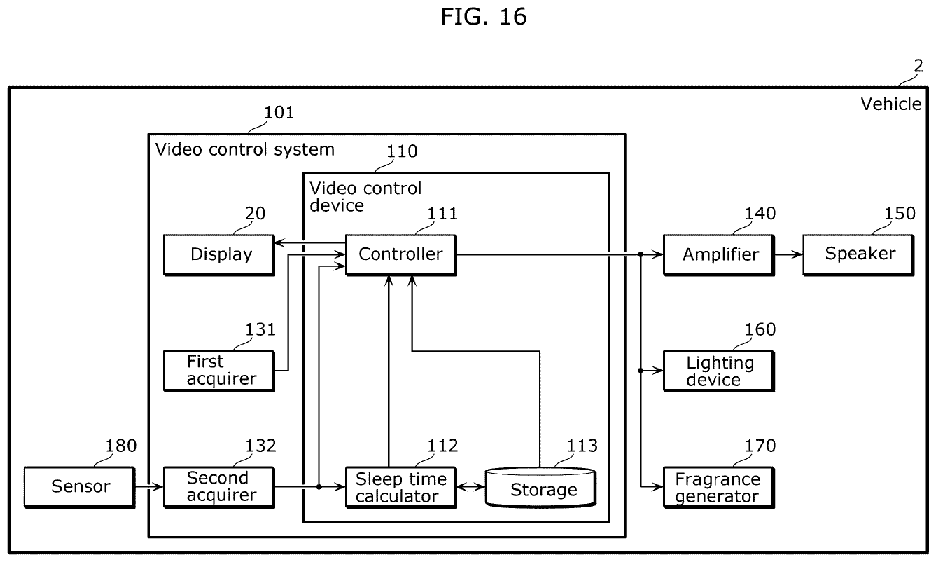

The configuration of a video control system in Embodiment 4 will first be described with reference to FIG. 16. FIG. 16 is a block diagram showing the configuration of video control system 101 in Embodiment 4.

Video control system 101 is a system which displays a video, and is utilized, for example, when television is watched, a business meeting is conducted, or tourist information is provided. Video control system 101 displays a video to perform fatigue recovery support. The fatigue recovery support is that video control system 101 controls the space inside vehicle 2 so that a user riding in vehicle 2 can take a temporary rest.

When video control system 101 performs the fatigue recovery support, video control system 101 may adjust sound, light, fragrance, and the like in addition to displaying a video. In other words, video control system 101 may control, in addition to display 20 which will be described later, amplifier 140, speaker 150, lighting device 160, and fragrance generator 170 which will be described later. In this way, video control system 101 can enhance the degree of fatigue recovery of the user. The details of the fatigue recovery support will be described later.

As shown in FIG. 16, video control system 101 includes video control device 110, display 20, first acquirer 131, and second acquirer 132. Video control system 101 is provided in vehicle 2.

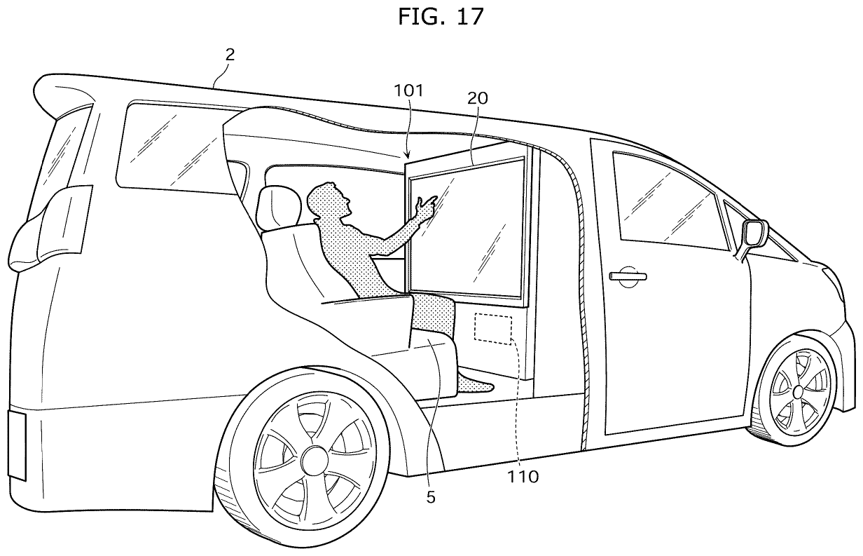

Display 20 is, for example, a liquid crystal display or an organic electro luminescence (EL) display. FIG. 17 is a diagram showing vehicle 2 and display 20 provided in vehicle 2.

As shown in FIG. 17, display 20 is provided between the front seat and rear seat 5 in vehicle 2. Display 20 is disposed along the vertical direction to separate the front seat from rear seat 5 such that a display surface is directed to rear seat 5, and a rear surface is directed to the front seat. The size of display 20 is, for example, greater than or equal to 40 inches and less than or equal to 60 inches.

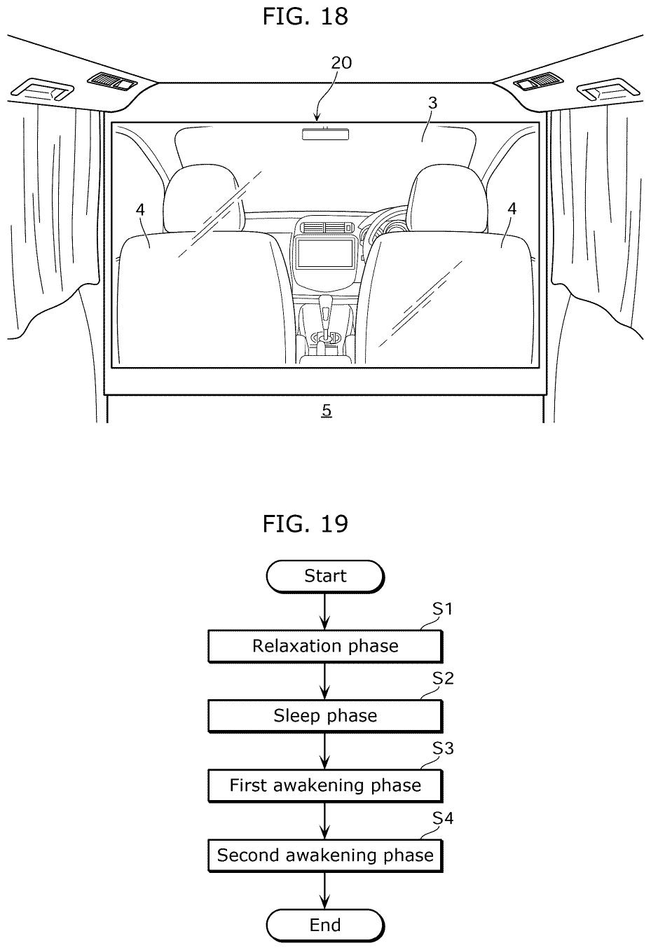

Display 20 includes a dimming film (sheet) having a variable light transmittance. FIG. 18 is a diagram when display 20 is viewed from rear seat 5 of vehicle 2.

As shown in FIG. 18, the user sitting in rear seat 5 can visually recognize front seat 4 through display 20. The user also can visually recognize the outside of vehicle 2 through display 20 and windshield 3. Display 20 has optical transparency which allows the user sitting in rear seat 5 to visually recognize the outside of vehicle 2 on the side of front seat 4.

Display 20 is set to reproduce predetermined video content. Although in the present specification, the video content is described as moving images, the video content may be a still image. In the present specification, “reproduce the video content” may be replaced by “display the video content”.

With reference back to FIG. 16, video control device 110 controls display of display 20 provided in vehicle 2. Although FIG. 16 shows an example where video control device 110 and display 20 are different constituent elements, the present disclosure is not limited to this example, and video control device 110 may be incorporated into the housing of display 20. Video control device 110 may be formed with a part of an electronic control unit (ECU) in vehicle 2. Video control device 110 may control not only the display on display 20 but also amplifier 140, speaker 150, lighting device 160, and fragrance generator 170 which will be described later. For example, video control device 110 may control sound, light, and fragrance in accordance with video content reproduced by display 20.

Video control device 110 includes controller 111, sleep time calculator 112, and storage 113.

Controller 111 is a processing unit which reproduces (or displays) video content on display 20. Although controller 111 is realized, for example, by a microcomputer, controller 111 may be realized by a processor. For example, a microcomputer, a processor, or the like of controller 111 executes computer programs stored in storage 113, and thus the functions of controller 111 are realized.

When video control system 101 performs the fatigue recovery support, controller 111 identifies an item of video content from a plurality of items of video content based on driving information acquired by first acquirer 131 and the level of awakening acquired by second acquirer 132, and causes the item of video content identified to be reproduced (or displayed) on display 20. Controller 111 may reference the sleep time of the user calculated by sleep time calculator 112 to identify an item of video content from a plurality of items of video content.

The driving information is information related to the driving status of vehicle 2. Specifically, the driving information includes information on whether vehicle 2 is driving or stopped and information on the speed, the acceleration and deceleration, the orientation, and the like of vehicle 2. The driving information is, for example, information obtained from the parking brake, the accelerator pedal, the steering wheel, or the like of vehicle 2.

The level of awakening is an index which indicates the degree of awakening of the user ranging from sleep to excitement. The level of awakening is calculated, for example, from the movement of eyes, the degree of opening of eyelids, the degree of opening of a mouth, a pulse rate, a time it takes to respond to an external stimulus. The level of awakening is, for example, an index which indicates a larger value as the state changes from a sleep state to an excited state. The level of awakening may be expressed by a continuous numerical value, or may be expressed by a discrete numerical value such as level 1 or level 2.

Sleep time calculator 112 is a processing unit which calculates the sleep time of the user based on information related to the level of awakening acquired by second acquirer 132. For example, sleep time calculator 112 calculates the sleep time of the user from a variation in the movement of the eyes, the degree of opening of the eyelids, the degree of opening of the mouth, the pulse rate, the time it takes to respond to an external stimulus, or the like. Although sleep time calculator 112 is realized, for example, by a microcomputer, sleep time calculator 112 may be realized by a processor. For example, the microcomputer, the processor, or the like of sleep time calculator 112 executes computer programs stored in storage 113, and thus the functions of sleep time calculator 112 are realized.

Storage 113 stores a plurality of items of video content, computer programs executed by controller 111 and sleep time calculator 112, and the like. Storage 113 is realized, for example, by a semiconductor memory.

First acquirer 131 is a processing unit which acquires the driving information described above, and is, for example, a communication circuit.

Second acquirer 132 is a processing unit which acquires the information related to the level of awakening of the user sitting in rear seat 5 of vehicle 2 from sensor 180 which will be described later, and is, for example, a communication circuit.

As shown in FIG. 16, vehicle 2 includes video control system 101, amplifier 140, speaker 150, lighting device 160, fragrance generator 170, and sensor 180.

Examples of vehicle 2 include a private car (see FIG. 17), a commercial vehicle, a taxi, a truck, a bus, and the like. The configuration of vehicle 2 is not limited to a configuration in which vehicle 2 has four wheels, and may be a configuration in which vehicle 2 has two or three wheels, or five or more wheels.

Amplifier 140 amplifies signals from a player or the like included in vehicle 2, and outputs the signals to speaker 150.

Speaker 150 converts the signals output from amplifier 140 into sound, and emits the sound toward the interior of vehicle 2.

Lighting device 160 is a lighting fixture which can adjust the color and the intensity of light. Although lighting device 160 is realized, for example, by a light emitting diode (LED) element, lighting device 160 may be realized by another light emitting element such as a semiconductor laser, an organic electro-luminescence (EL) display, or an inorganic EL display.

Fragrance generator 170 is a device which generates fragrance toward the interior of vehicle 2. Fragrance generator 170 is realized, for example, by an aroma diffuser.

Sensor 180 is realized, for example, by a camera. Sensor 180 is placed in a position capable of imaging the user sitting in rear seat 5 of vehicle 2. Sensor 180 is placed, for example, around display 20 shown in FIG. 18 (more specifically, on the edge of display 20). Sensor 180 is placed, for example, in a position capable of imaging the upper body or the whole body of the user sitting in rear seat 5.

Sensor 180 may include an information processing circuit. Specifically, in sensor 180, the information processing circuit may perform image processing based on the acquired image to calculate the level of awakening, and transmit the level of awakening calculated to second acquirer 132 in video control system 101. The information processing circuit calculates the level of awakening of the user, for example, from the movement of the eyes, the degree of opening of the eyelids, or the like based on the acquired image.

Sensor 180 may transmit the acquired image to second acquirer 132 in video control system 101 as the information related to the level of awakening. In this case, video control system 101 performs image processing thereinside based on the acquired image to calculate the level of awakening.

Although an example of the size of display 20 has been described above, the size of display 20 is not limited to this example. For example, the size of display 20 may be less than or equal to 40 inches or greater than or equal to 60 inches in accordance with the size of the space inside vehicle 2.

Although an example where video content reproduced (or displayed) on display 20 is stored in storage 113 has been described above, the present disclosure is not limited to this example. For example, video content reproduced (or displayed) on display 20 may be transmitted by video streaming service, or may be stored in a recording medium such as a digital versatile disc (DVD), a Blu-ray (registered trademark) disc (BD), or a hard disk.

Although an example where sensor 180 is realized by a camera has been described above, the present disclosure is not limited to this example. Sensor 180 may be, for example, a wearable device worn by the user sitting in rear seat 5. For example, sensor 180 may measure the pulse rate of the user, and transmit the measured pulse rate of the user to second acquirer 132 in video control system 101 as the information related to the level of awakening.

### About Fatigue Recovery Support

An outline of the fatigue recovery support performed by video control system 101 will be described below with reference to FIG. 19. FIG. 19 is a flowchart showing an operation of the fatigue recovery support performed by video control system 101 in Embodiment 4.

As shown in FIG. 19, the fatigue recovery support in Embodiment 4 includes four phases: a relax phase (S1); a sleep phase (S2); a first awakening phase (S3); and a second awakening phase (S4). Each of the phases will then be described.

### (1) Relaxation Phase

In the relaxation phase, video content which encourages the user sitting in rear seat 5 to relax is displayed on display 20. The video content which encourages the user to relax is, for example, video content which displays a forest or a bonfire. In the relaxation phase, video control system 101 can relieve the tension of the user and encourage the user to relax by displaying, on display 20, the video content which encourages the user to relax. The video content which encourages the user to relax may be video content which displays the sea and the sunset. For example, in the relaxation phase, video control system 101 displays, on display 20, video content depicting the sun setting over the sea, and thereby causes the user to be aware of the end of an active day, with the result that the user can be encouraged to relax.

When in the relaxation phase, the video content which encourages the user to relax is displayed on display 20, sound corresponding to the video content which encourages the user to relax may be emitted from speaker 150. Likewise, in the relaxation phase, illumination light having a color and an intensity corresponding to the video content which encourages the user to relax may be emitted from lighting device 160. Likewise, in the relaxation phase, fragrance corresponding to the video content which encourages the user to relax may be generated from fragrance generator 170. When a vibration generator which provides vibration to the user sitting in rear seat 5 is included in vehicle 2, in the relaxation phase, vibration corresponding to the video content which encourages the user to relax may be generated from the vibration generator. In this way, the user is encouraged to relax not only through the sense of sight but also through the sense of hearing, the sense of smell, and the sense of touch.

### (2) Sleep Phase

In the sleep phase, video content which encourages the user sitting in rear seat 5 is displayed on display 20. The video content which encourages the user to sleep is, for example, video content which has relatively low brightness. In the sleep phase, video control system 101 displays, on display 20, the video content which encourages the user to sleep as described above, and thereby can encourage the user to sleep.

When in the sleep phase, the video content which encourages the user to sleep is displayed on display 20, sound corresponding to the video content which encourages the user to sleep may be emitted from speaker 150. Likewise, in the sleep phase, illumination light having a color and an intensity corresponding to the video content which encourages the user to sleep may be emitted from lighting device 160. Likewise, in the sleep phase, fragrance corresponding to the video content which encourages the user to sleep may be generated from fragrance generator 170. When the vibration generator which provides vibration to the user sitting in rear seat 5 is included in vehicle 2, in the sleep phase, vibration corresponding to the video content which encourages the user to sleep may be generated from the vibration generator. In this way, the user is encouraged to sleep not only through the sense of sight but also through the sense of hearing, the sense of smell, and the sense of touch.

In Embodiment 4, the time of the sleep phase is about 10 minutes. The reason why the time of the sleep phase is set to about 10 minutes is because it is said that people can refresh themselves through sleep for about 10 minutes. In experiments conducted by the inventors, the feeling of refreshment experienced by people from sleep tends to increase monotonically up to 10 minutes after the start of sleep, but after 10 minutes, it tends to gradually decrease. Based on the results of the experiments as described above, the inventors set the time of the sleep phase to about 10 minutes. The time of the sleep phase shown above is merely an example, and for example, the time of the sleep phase may be set to 10 minutes or less, such as about 5 minutes, or may be set to 10 minutes or more, such as about 15 minutes.

### (3) First Awakening Phase

In the first awakening phase, video content which encourages the user sitting in rear seat 5 to awake is displayed on display 20. The video content which encourages the user to awake may be, for example, video content in which animals in the forest bathed in the morning sun become active. Video control system 101 displays, on display 20, the video content which encourages the user to awake as described above, and thereby causes the user to be aware of the start of an active day, with the result that the user can be encouraged to awake.

When in the first awakening phase, the video content which encourages the user to awake is displayed on display 20, sound corresponding to the video content which encourages the user to awake may be emitted from speaker 150. Likewise, in the first awakening phase, illumination light having a color and an intensity corresponding to the video content which encourages the user to awake may be emitted from lighting device 160. Likewise, in the first awakening phase, fragrance corresponding to the video content which encourages the user to awake may be generated from fragrance generator 170. When the vibration generator which provides vibration to the user sitting in rear seat 5 is included in vehicle 2, in the first awakening phase, vibration corresponding to the video content which encourages the user to awake may be generated from the vibration generator. In this way, the user is encouraged to awake not only through the sense of sight but also through the sense of hearing, the sense of smell, and the sense of touch.

### (4) About Second Awakening Phase

The inventors have found that the second awakening phase is provided in the fatigue recovery support, and thus it is possible to further encourage the user to awake. Specifically, in the second awakening phase, video content which encourages the user sitting in rear seat 5 to exercise is displayed on display 20.

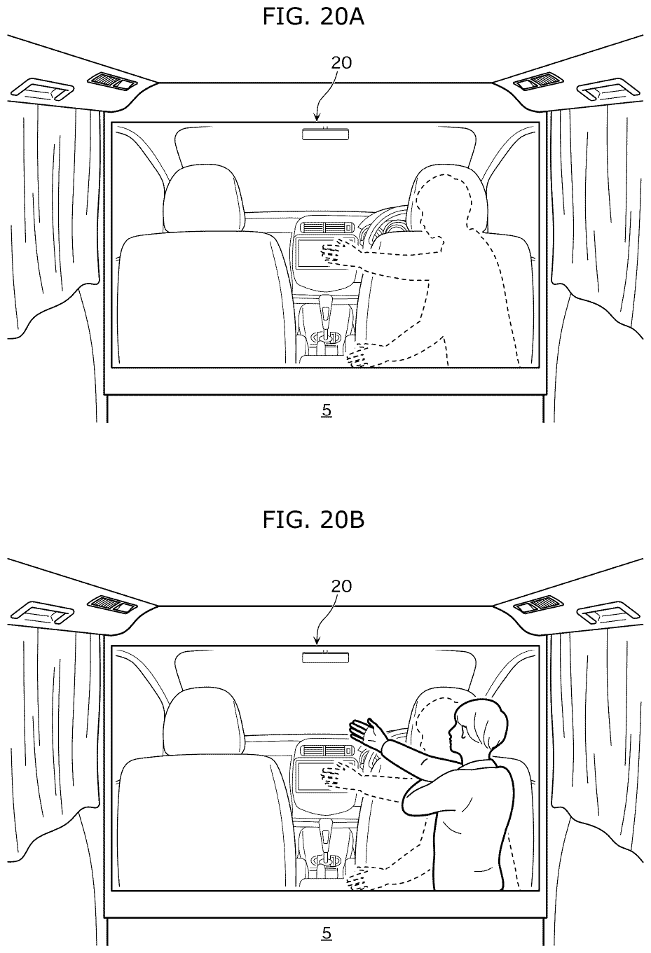

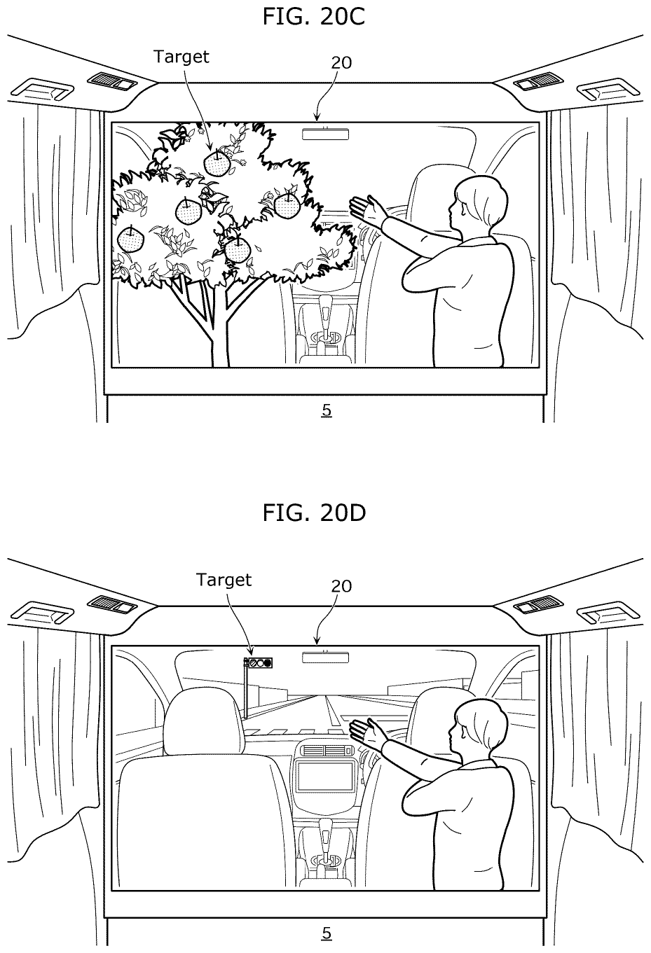

The video content which encourages the user to exercise is, for example, video content in which when the user exercises, a target posture in the exercise is displayed (see FIG. 20A). FIG. 20A is a diagram showing a first example of the video content. In the present specification, the video content displayed on display 20 in the second awakening phase may be referred to as the “exercise video content”.

Display 20 displays the video content which displays the target posture (in an example shown in FIG. 20A, dashed lines) when the user exercises. Video control system 101 displays, on display 20, the video content which encourages the user to exercise as described above, and thus the user can take the target posture in the state of the body. In this way, the user is encouraged to awake not only by viewing the video content displayed on display 20 (that is, only through the sense of sight) but also by actually moving the body.

As shown in FIG. 20A, the light transmittance of a part other than a region part where the target posture of the user is displayed in a region where display 20 can display video content (that is, a display part) is higher than the light transmittance of the region part where the posture is displayed. The user sitting in rear seat 5 can visually recognize front seat 4 through display 20, and can visually recognize the outside of vehicle 2 through display 20 and windshield 3. In this way, the user can exercise while checking the driving status of vehicle 2, and thus the user is not prone to car sickness.

Although in the example shown in FIG. 20A, the light transmittance of the region part where the target posture of the user is displayed is low, and thus in the region part, the user cannot visually recognize the front (that is, front seat 4 and the outside of vehicle 2), the present disclosure is not limited to this example. Video control system 101 may change the light transmittance of the region part according to the driving status of vehicle 2 (that is, the driving information). In this way, the user easily visually recognizes front seat 4 through display 20 and the outside of vehicle 2 through display 20 and windshield 3.

When the video content which encourages the user to exercise as shown in FIG. 20A is displayed on display 20, an instruction such as “Move your body as shown in the video” may be displayed on display 20, or may be transmitted using sound via speaker 150.

When the video content which encourages the user to exercise as shown in FIG. 20A is displayed on display 20, for example, video content of the sea, forest, or the like may be superimposed and displayed in the lower half of display 20. In this way, the user can exercise in a relaxed environment.

When the video content which encourages the user to exercise as shown in FIG. 20A is displayed on display 20, sound corresponding to the video content which encourages the user to exercise may be emitted from speaker 150. Likewise, illumination light having a color and an intensity corresponding to the video content which encourages the user to exercise may be emitted from lighting device 160. Likewise, fragrance corresponding to the video content which encourages the user to exercise may be generated from fragrance generator 170. When the vibration generator which provides vibration to the user sitting in rear seat 5 is included in vehicle 2, vibration corresponding to the video content which encourages the user to exercise may be generated from the vibration generator. In this way, the user is encouraged to awake not only through the sense of sight but also through the sense of hearing, the sense of smell, and the sense of touch.

The video content which encourages the user to exercise may be video content (see FIG. 20B) in which when the user exercises, the target posture in the exercise and the current posture of the user are displayed. FIG. 20B is a diagram showing a second example of the video content.

Display 20 displays the video content in which when the user exercises, the target posture (in the example shown in FIG. 20B, dashed lines) of the user and the current posture (in the example shown in FIG. 20B, solid lines) of the user are displayed. Video control system 101 displays, on display 20, the video content which encourages the user to exercise as described above, and thus the user can recognize the state of the body to take the target posture. In this way, the user is encouraged to awake not only by viewing the video content displayed on display 20 (that is, only through the sense of sight) but also by actually moving the body.

As shown in FIG. 20B, the light transmittance of a part other than a region part where the target posture of the user and the current posture of the user are displayed in the region where display 20 can display video content (that is, the display part) is higher than the light transmittance of the region part where the posture is displayed. The user sitting in rear seat 5 can visually recognize front seat 4 through display 20, and can visually recognize the outside of vehicle 2 through display 20 and windshield 3. In this way, the user can exercise while checking the driving status of vehicle 2, and thus the user is not prone to car sickness.

Video control system 101 may change, according to the driving status (that is, the driving information) of vehicle 2, the light transmittance of the region part where the target posture of the user and the current posture of the user are displayed. In this way, the user easily visually recognizes front seat 4 through display 20 and the outside of vehicle 2 through display 20 and windshield 3.

When the video content which encourages the user to exercise as shown in FIG. 20B is displayed on display 20, an instruction such as “Move your body as shown in the video” may be displayed on display 20, or may be transmitted using sound via speaker 150.

When the video content which encourages the user to exercise as shown in FIG. 20B is displayed on display 20, for example, the video content of the sea, forest, or the like may be superimposed and displayed in the lower half of display 20. In this way, the user can exercise in a relaxed environment.

When the video content which encourages the user to exercise as shown in FIG. 20B is displayed on display 20, sound corresponding to the video content which encourages the user to exercise may be emitted from speaker 150. Likewise, illumination light having a color and an intensity corresponding to the video content which encourages the user to exercise may be emitted from lighting device 160. Likewise, fragrance corresponding to the video content which encourages the user to exercise may be generated from fragrance generator 170. When the vibration generator which provides vibration to the user sitting in rear seat 5 is included in vehicle 2, vibration corresponding to the video content which encourages the user to exercise may be generated from the vibration generator. In this way, the user is encouraged to awake not only through the sense of sight but also through the sense of hearing, the sense of smell, and the sense of touch.

The video content which encourages the user to exercise may be video content (see FIG. 20C) in which when the user exercises, a target in the exercise is displayed. FIG. 20C is a diagram showing a third example of the video content.

Display 20 displays video content in which when the user exercises, the target in the exercise (in an example shown in FIG. 20C, an apple) is displayed. Video control system 101 displays, on display 20, the video content which encourages the user to exercise as described above, and thus the user can appropriately exercise only by moving the body toward the target. In this way, the user is encouraged to awake not only by viewing the video content displayed on display 20 (that is, only through the sense of sight) but also by actually moving the body.

In the example shown in FIG. 20C, the current posture (solid lines) of the user is displayed on display 20. The user can exercise while checking whether the user is recognizing the state of the body and is moving the body toward the target. In this way, video control system 101 can more effectively encourage the user to awake.

As shown in FIG. 20C, the light transmittance of a part other than a region part where the target, a video other than the target (for example, an apple tree), and the current posture of the user are displayed in the region where display 20 can display video content (that is, the display part) is higher than the light transmittance of the region part where the posture is displayed. The user sitting in rear seat 5 can visually recognize front seat 4 through display 20, and can visually recognize the outside of vehicle 2 through display 20 and windshield 3. In this way, the user can exercise while checking the driving status of vehicle 2, and thus the user is not prone to car sickness.

Video control system 101 may change, according to the driving status (that is, the driving information) of vehicle 2, the light transmittance of the region part where the target, the video other than the target (for example, the apple tree), and the current posture of the user are displayed. In this way, the user easily visually recognizes front seat 4 through display 20 and the outside of vehicle 2 through display 20 and windshield 3.

When the video content which encourages the user to exercise as shown in FIG. 20C is displayed on display 20, an instruction such as “Move your body to touch the apple at the top” may be displayed on display 20, or may be transmitted using sound via speaker 150.

When the video content which encourages the user to exercise as shown in FIG. 20C is displayed on display 20, the light transmittance of the target may be lowered as compared with the light transmittance of the video other than the target (for example, the apple tree), or a mark (for example, a circle) may be provided to the target so that the user easily recognizes the position of the target.

When the video content which encourages the user to exercise as shown in FIG. 20C is displayed on display 20, sound corresponding to the video content which encourages the user to exercise may be emitted from speaker 150. Likewise, illumination light having a color and an intensity corresponding to the video content which encourages the user to exercise may be emitted from lighting device 160. Likewise, fragrance corresponding to the video content which encourages the user to exercise may be generated from fragrance generator 170. When the vibration generator which provides vibration to the user sitting in rear seat 5 is included in vehicle 2, vibration corresponding to the video content which encourages the user to exercise may be generated from the vibration generator. In this way, the user is encouraged to awake not only through the sense of sight but also through the sense of hearing, the sense of smell, and the sense of touch.

The video content which encourages the user to exercise may be video content (see FIG. 20D) in which when the user exercises, a target which is a target in the exercise and is present on a driving environment is utilized. FIG. 20D is a diagram showing a fourth example of the video content. The target may be, for example, a traffic light (hatched part in an example shown in FIG. 20D), a sign, or the like existing on the road.

Display 20 displays the video content in which when the user exercises, the target (in an example shown in FIG. 20D, the traffic light) which is a target in the exercise and is present on the driving environment (for example, the road) is displayed. Video control system 101 displays, on display 20, the video content which encourages the user to exercise as described above, and thus the user can appropriately exercise only by moving the body toward the target. In this way, the user is encouraged to awake not only by viewing the video content displayed on display 20 (that is, only through the sense of sight) but also by actually moving the body.

In the example shown in FIG. 20D, the current posture (solid lines) of the user is displayed on display 20. The user can exercise while checking whether the user is recognizing the state of the body and is moving the body toward the target. In this way, video control system 101 can more effectively encourage the user to awake.

As shown in FIG. 20D, the light transmittance of a part other than a region part where the current posture of the user is displayed in the region where display 20 can display video content (that is, the display part) is higher than the light transmittance of the region part where the posture is displayed. The user sitting in rear seat 5 can visually recognize front seat 4 through display 20, and can visually recognize the outside of vehicle 2 through display 20 and windshield 3. In this way, the user can exercise while checking the driving status of vehicle 2, and thus the user is not prone to car sickness.

Video control system 101 may change, according to the driving status (that is, the driving information) of vehicle 2, the light transmittance of the region part where the current posture of the user is displayed. In this way, the user easily visually recognizes front seat 4 through display 20 and the outside of vehicle 2 through display 20 and windshield 3.

When the video content which encourages the user to exercise as shown in FIG. 20D is displayed on display 20, an instruction such as “Move your body to touch the traffic light” may be displayed on display 20, or may be transmitted using sound via speaker 150.

When the video content which encourages the user to exercise as shown in FIG. 20D is displayed on display 20, a mark (for example, a circle) may be provided to the target so that the user easily recognizes the position of the target.

When the video content which encourages the user to exercise as shown in FIG. 20D is displayed on display 20, sound corresponding to the video content which encourages the user to exercise may be emitted from speaker 150. Likewise, illumination light having a color and an intensity corresponding to the video content which encourages the user to exercise may be emitted from lighting device 160. Likewise, fragrance corresponding to the video content which encourages the user to exercise may be generated from fragrance generator 170. When the vibration generator which provides vibration to the user sitting in rear seat 5 is included in vehicle 2, vibration corresponding to the video content which encourages the user to exercise may be generated from the vibration generator. In this way, the user is encouraged to awake not only through the sense of sight but also through the sense of hearing, the sense of smell, and the sense of touch.

### Variation of Video Content Which Encourages User to Exercise

A variation of the video content which encourages the user to exercise will be described below.

The video content which encourages the user to exercise may include a plurality of items of exercise video content each of which encourages the user to exercise at different levels of intensity. For example, the video content which encourages the user to exercise may include exercise video content indicating a first level of exercise intensity and exercise video content indicating a second level of exercise intensity which is higher than the first level of exercise intensity. As compared with the exercise video content indicating the first level of exercise intensity, in the exercise video content indicating the second level of exercise intensity, for example, the target posture of the user is different, or the distance between the user sitting in rear seat 5 and the target is different.

Although an example where the exercise intensity of the exercise video content is classified into two stages has been described, the exercise intensity of the exercise video content may be classified into three or more stages.

### Operation

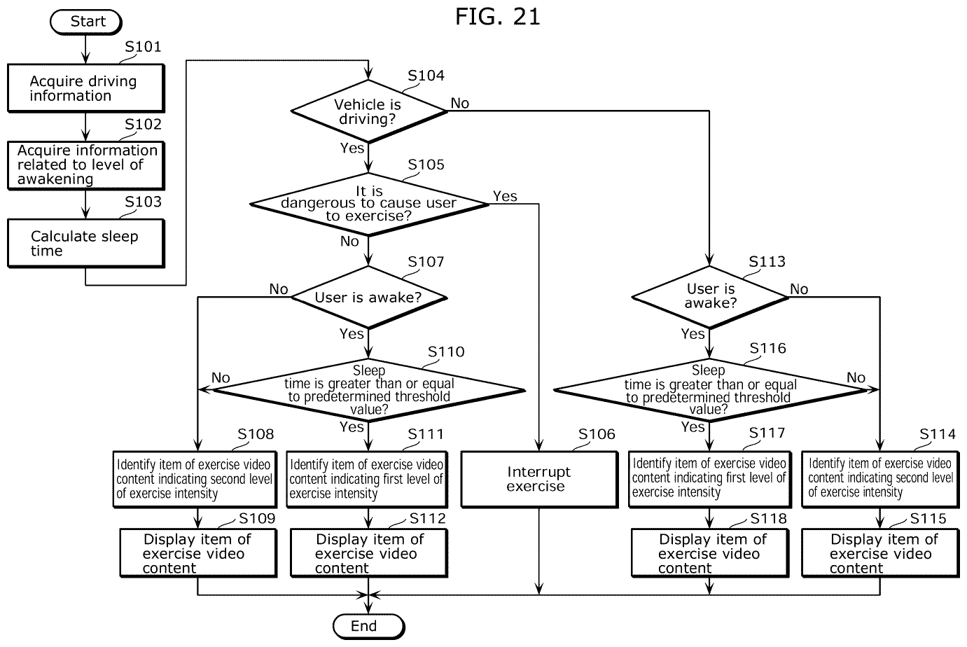

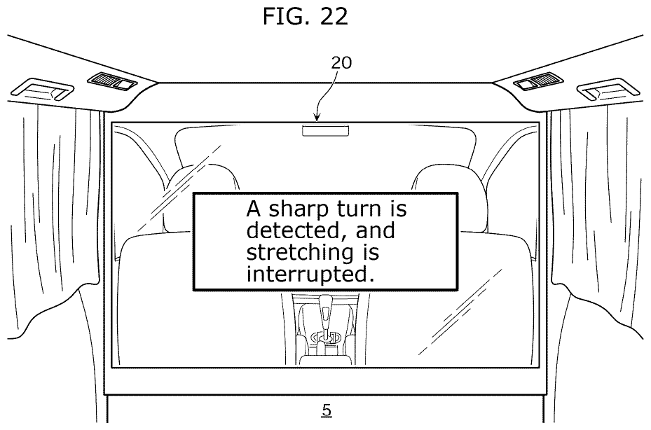

The operation of video control system 101 in Embodiment 4 will be described below with reference to FIG. 21. FIG. 21 is a flowchart showing the operation performed by video control system 101 in Embodiment 4 in the second awakening phase shown in FIG. 19.

First acquirer 131 first acquires the driving information (S101). Second acquirer 132 acquires, from sensor 180, the information related to the level of awakening of the user sitting in rear seat 5 (S102).

Sleep time calculator 112 calculates the sleep time of the user sitting in rear seat 5 based on the information related to the level of awakening acquired in step S102 (S103).

Controller 111 determines, based on the driving information acquired in step S101, whether vehicle 2 is driving (S104).

When controller 111 determines that vehicle 2 is driving (yes in S104), controller 111 determines, based on the driving information acquired in step S101, whether it is dangerous to cause the user to exercise (S105). The timing at which it is dangerous to cause the user to exercise is, for example, a timing at which a sudden start or sudden braking of vehicle 2, or a sharp turn or the like is detected.

When controller 111 determines that it is dangerous to cause the user to exercise (yes in S105), controller 111 interrupts the exercise in the second awakening phase (S106). In other words, controller 111 does not display, on display 20, the video content which encourages the user to exercise. Here, controller 111 may display, on display 20, a notification indicating the interruption of the exercise. FIG. 22 is a diagram showing an example of the notification displayed on display 20. In FIG. 22, as an example of the notification indicating the interruption of the exercise, a notification “A sharp turn is detected, and stretching is interrupted.” is displayed on the front of display 20.

With reference back to FIG. 21, when controller 111 determines that it is not dangerous to cause the user to exercise (no in S105), controller 111 determines, based on the information related to the level of awakening acquired in step S102, whether the user is awake (S107).

When controller 111 determines that the user is not awake (no in step S107), controller 111 identifies an item of exercise video content which indicates the second level of exercise intensity (S108). Then, controller 111 causes the item of exercise video content identified in step S108 to be displayed on display 20 (S109).

On the other hand, when controller 111 determines that the user is awake (yes in step S107), controller 111 determines whether the sleep time calculated in step S103 is greater than or equal to a predetermined threshold value (S110). The predetermined threshold value is, for example, 10 minutes.

When controller 111 determines that the sleep time calculated in step S103 is less than the predetermined threshold value (no in S110), the processing transfers to step S108 described above.

On the other hand, controller 111 determines that the sleep time calculated in step S103 is greater than or equal to the predetermined threshold value (yes in S110), controller 111 identifies an item of exercise video content which indicates the first level of exercise intensity (S111). Then, controller 111 causes the item of exercise video content identified in step S111 to be displayed on display 20 (S112).

On the other hand, when controller 111 determines that vehicle 2 is not driving (no in S104), controller 111 determines, based on the information related to the level of awakening acquired in step S102, whether the user is awake (S113).

When controller 111 determines that the user is not awake (no in step S113), controller 111 identifies an item of exercise video content which indicates the second level of exercise intensity (S114). Then, controller 111 causes the item of exercise video content identified in step S114 to be displayed on display 20 (S115).

In step S115, the light transmittance of display 20 may be the same as the light transmittance of display 20 in step S109 or step S112, or may be the minimum value in a settable range. In other words, in step S115, the light transmittance of display 20 may be set such that the user sitting in rear seat 5 can visually recognize front seat 4 through display 20, and can visually recognize the outside of vehicle 2 through display 20 and windshield 3, or may be set such that the user sitting in rear seat 5 cannot visually recognize front seat 4 through display 20, and cannot visually recognize the outside of vehicle 2 through display 20 and windshield 3.

On the other hand, when controller 111 determines that the user is awake (yes in step S113), controller 111 determines whether the sleep time calculated in step S103 is greater than or equal to the predetermined threshold value (S116).

When controller 111 determines that the sleep time calculated in step S103 is less than the predetermined threshold value (no in S116), the processing transfers to step S114 described above.

On the other hand, controller 111 determines that the sleep time calculated in step S103 is greater than or equal to the predetermined threshold value (yes in S116), controller 111 identifies an item of exercise video content which indicates the first level of exercise intensity (S117). Then, controller 111 causes the item of exercise video content identified in step S117 to be displayed on display 20 (S118).

In step S118, the light transmittance of display 20 may be the same as the light transmittance of display 20 in step S109 or step S112, or may be the minimum value in the settable range. In other words, in step S118, the light transmittance of display 20 may be set such that the user sitting in rear seat 5 can visually recognize front seat 4 through display 20, and can visually recognize the outside of vehicle 2 through display 20 and windshield 3, or may be set such that the user sitting in rear seat 5 cannot visually recognize front seat 4 through display 20, and cannot visually recognize the outside of vehicle 2 through display 20 and windshield 3.

Since in video control system 101, display 20 has optical transparency such that the user sitting in rear seat 5 can visually recognize the outside of vehicle 2 on the side of front seat 4, the user can grasp the driving status of vehicle 2 when exercising according to the display on display 20. In this way, video control system 101 can cause the user to be unlikely to be car sick even when the user exercises according to the display on display 20.

When video control system 101 causes the user who sits in rear seat 5 after taking a temporary rest in vehicle 2 to awake, the exercise video content corresponding to the level of awakening of the user can be displayed on display 20. In this way, video control system 101 can more effectively encourage the user to awake.

Since video control system 101 further identifies an item of video content from a plurality of items of video content with consideration given to the sleep time of the user, video control system 101 can more effectively encourage the user to awake. More specifically, when video control system 101 causes the user who sits in rear seat 5 after taking a temporary rest in vehicle 2 to awake, the exercise video content suitable for the calculated length of the sleep time of the user can be displayed on display 20. In this way, video control system 101 can more effectively encourage the user to awake.

Video control system 101 can cause the user who sits in rear seat 5 after taking a temporary rest in vehicle 2 to awake while ensuring the safety of the user.

### Effects and Like

The effects of video control system 101 and the like in Embodiment 4 will be described below.

Video control system 101 in Embodiment 4 includes: display 20 that is provided between front seat 4 and rear seat 5 in vehicle 2; first acquirer 131 that acquires driving information related to a driving status of vehicle 2; second acquirer 132 that acquires information related to a level of awakening indicating a degree of awakening ranging from sleep to excitement of a user sitting in rear seat 5; and controller 111 that identifies, based on the driving information acquired and the information related to the level of awakening acquired, an item of video content from a plurality of items of video content, and causes the item of video content identified to be displayed on display 20, display 20 has optical transparency to allow the user sitting in rear seat 5 to visually recognize an outside of vehicle 2 on a side of front seat 4, and the plurality of items of video content include video content that encourages the user to exercise.

Since in video control system 101 described above, display 20 has optical transparency such that the user sitting in rear seat 5 can visually recognize the outside of vehicle 2 on the side of front seat 4, the user can grasp the driving status of vehicle 2 when exercising according to the display on display 20. In this way, video control system 101 can cause the user to be unlikely to be car sick even when the user exercises according to the display on display 20. Hence, when video control system 101 causes the user sitting in rear seat 5 after taking a temporary rest in vehicle 2 to awake, video control system 101 can cause the physical condition of the user to be unlikely to be adversely affected.

In video control system 101 in Embodiment 4, controller 111 changes, based on the driving information acquired, the light transmittance of the item of video content displayed on display 20.

Video control system 101 as described above can cause the user to more easily grasp the driving status of vehicle 2 according to the driving information acquired by first acquirer 131. In this way, when video control system 101 causes the user sitting in rear seat 5 after taking a temporary rest in vehicle 2 to awake, video control system 101 can cause the physical condition of the user to be unlikely to be adversely affected.

In video control system 101 in Embodiment 4, the video content that encourages the user to exercise includes a plurality of items of exercise video content that encourage the user to exercise at different levels of intensity, when controller 111 determines, based on the information related to the level of awakening acquired, that the user is awake, controller 111 identifies, from the plurality of items of exercise video content, an item of exercise video content indicating a first level of exercise intensity, and causes the item of exercise video content identified to be displayed on display 20, and when controller 111 determines, based on the information related to the level of awakening acquired, that the user is not awake, controller 111 identifies, from the plurality of items of exercise video content, an item of exercise video content indicating a second level of exercise intensity higher than the first level of exercise intensity, and causes the item of exercise video content identified to be displayed on display 20.

When video control system 101 as described above causes the user who sits in rear seat 5 after taking a temporary rest in vehicle 2 to awake, the exercise video content corresponding to the level of awakening of the user can be displayed on display 20. In this way, video control system 101 can more effectively encourage the user to awake.

Video control system 101 in Embodiment 4, further includes: sleep time calculator 112 that calculates a sleep time of the user based on the information related to the level of awakening acquired, and controller 111 identifies an item of video content from the plurality of items of video content based on the driving information acquired, the information related to the level of awakening acquired, and the sleep time of the user calculated, and causes the item of video content identified to be displayed on display 20.

Since video control system 101 as described above further identifies an item of video content from a plurality of items of video content with consideration given to the sleep time of the user, video control system 101 can more effectively encourage the user to awake.

In video control system 101 in Embodiment 4, the video content that encourages the user to exercise includes a plurality of items of exercise video content that encourage the user to exercise at different levels of intensity, when controller 111 determines that the sleep time of the user calculated is greater than or equal to a predetermined threshold value, controller 111 identifies, from the plurality of items of exercise video content, an item of exercise video content indicating a first level of exercise intensity, and causes the item of exercise video content identified to be displayed on display 20, and when controller 111 determines that the sleep time of the user calculated is less than the predetermined threshold value, controller 111 identifies, from the plurality of items of exercise video content, an item of exercise video content indicating a second level of exercise intensity higher than the first level of exercise intensity, and causes the item of exercise video content identified to be displayed on display 20.

When video control system 101 as described above causes the user who sits in rear seat 5 after taking a temporary rest in vehicle 2 to awake, the exercise video content suitable for the calculated length of the sleep time of the user can be displayed on display 20. In this way, video control system 101 can more effectively encourage the user to awake.

In video control system 101 in Embodiment 4, the plurality of items of video content include video content in which when the user exercises, a target posture in the exercise is displayed.

Since video control system 101 as described above displays, on display 20, the video content displaying the target posture in the exercise, the user can take the target posture in the state of the body by checking the video content displayed on display 20. In this way, video control system 101 can more effectively encourage the user to awake.

In video control system 101 in Embodiment 4, the plurality of items of video content include video content in which when the user exercises, a target posture in the exercise and a current posture of the user are displayed.

Since video control system 101 as described above displays, on display 20, the video content displaying the target posture in the exercise and the current posture of the user, the user can recognize the state of the body to take the target posture by checking the video content displayed on display 20. In this way, video control system 101 can more effectively encourage the user to awake.

In video control system 101 in Embodiment 4, the plurality of items of video content include video content in which when the user exercises, a target in the exercise is displayed.

Since video control system 101 as described above displays, on display 20, the video content in which the target in the exercise is displayed, the user can appropriately exercise only by moving the body toward the target. In this way, video control system 101 can more effectively encourage the user to awake.

In video control system 101 in Embodiment 4, controller 111 determines, based on the driving information acquired, whether it is dangerous to cause the user to exercise, when controller 111 determines that it is not dangerous to cause the user to exercise, controller 111 continues to cause the item of video content to be displayed on display 20, and when controller 111 determines that it is dangerous to cause the user to exercise, controller 111 interrupts the displaying of the item of video content on display 20.

Video control system 101 as described above can cause the user who sits in rear seat 5 after taking a temporary rest in vehicle 2 to awake while ensuring the safety of the user.

A video control method in Embodiment 4 is performed by video control system 101, video control system 101 includes display 20 that is provided between front seat 4 and rear seat 5 in vehicle 2, the video control method includes: acquiring driving information related to a driving status of vehicle 2 (S101); acquiring information related to a level of awakening indicating a degree of awakening ranging from sleep to excitement of a user sitting in rear seat 5 (S102); and identifying, based on the driving information acquired and the information related to the level of awakening acquired, an item of video content from a plurality of items of video content, and causing the item of video content identified to be displayed on display 20 (S104 to S118), display 20 has optical transparency to allow the user sitting in rear seat 5 to visually recognize an outside of vehicle 4 on a side of front seat 4, and the plurality of items of video content include video that encourages the user to exercise.

Since in the video control method as described above, display 20 has optical transparency such that the user sitting in rear seat 5 can visually recognize the outside of vehicle 2 on the side of front seat 4, the user can grasp the driving status of vehicle 2 when exercising according to the display on display 20. In this way, the video control method can cause the user to be unlikely to be car sick even when the user exercises according to the display on display 20. Hence, when the video control method causes the user sitting in rear seat 5 after taking a temporary rest in vehicle 2 to awake, the video control method can cause the physical condition of the user to be unlikely to be adversely affected.

### Other Embodiments

Although the video control system and the like in the present disclosure have been described above based on the above embodiments, the present disclosure is not limited to the embodiments described above. Embodiments obtained by performing various types of variations conceived by those skilled in the art on the above embodiments and embodiments formed by combining constituent elements in different embodiments may be included in the scope of one or a plurality of aspects without departing from the spirit of the present disclosure.

In the embodiments described above, the constituent elements may be formed by dedicated hardware, or may be realized by executing software programs suitable for the constituent elements. A program executor such as a CPU or a processor may read and execute software programs recorded in a recording medium such as a hard disk or a semiconductor memory to realize the constituent elements.

A communication method between the devices in the embodiments described above is not particularly limited. In the communication between the devices, an unillustrated relay device may be interposed.

In the embodiments described above, processing executed by a specific processing unit may be executed by another processing unit. The order of a plurality of processing steps may be changed, or a plurality of processing steps may be executed in parallel.

In the embodiments described above, the video control system may be realized by one device, or may be realized by a plurality of devices. When the video control system is realized by a plurality of devices, how constituent elements (in particular, functional constituent elements) included in the video control system are distributed to the devices is not limited.

The constituent elements may be realized by hardware. For example, the constituent elements may be circuits (or an integrated circuit). These circuits may form one circuit as a whole, or may be separate circuits. These circuits may be general-purpose circuits or may be dedicated circuits.

General or specific aspects of the present disclosure may be realized by a system, a device, a method, an integrated circuit, a computer program, or a computer-readable recording medium such as a CD-ROM, or may be realized by any combination of a system, a device, a method, an integrated circuit, a computer program, and a recording medium.

For example, the present disclosure may be realized as a method which is executed by a computer system in the video control system, or may be realized as programs which cause a computer system to execute a method. The present disclosure may be realized as a non-transitory computer-readable recording medium in which these programs are recorded.

### Additional Notes

In Embodiment 4 described above, the following techniques are disclosed.

### Technique 1

A video control system includes: a display that is provided between a front seat and a rear seat in a vehicle; a first acquirer that acquires driving information related to a driving status of the vehicle; a second acquirer that acquires information related to a level of awakening indicating a degree of awakening ranging from sleep to excitement of a user sitting in the rear seat; and a controller that identifies, based on the driving information acquired and the information related to the level of awakening acquired, an item of video content from a plurality of items of video content, and causes the item of video content identified to be displayed on the display, the display has optical transparency to allow the user sitting in the rear seat to visually recognize an outside of the vehicle on a side of the front seat, and the plurality of items of video content include video content that encourages the user to exercise.

### Technique 2

In the video control system described in technique 1, the controller changes, based on the driving information acquired, a light transmittance of the item of video content displayed on the display.

### Technique 3

In the video control system described in technique 1 or 2, the video content that encourages the user to exercise includes a plurality of items of exercise video content that encourage the user to exercise at different levels of intensity, when the controller determines, based on the information related to the level of awakening acquired, that the user is awake, the controller identifies, from the plurality of items of exercise video content, an item of exercise video content indicating a first level of exercise intensity, and causes the item of exercise video content identified to be displayed on the display, and when the controller determines, based on the information related to the level of awakening acquired, that the user is not awake, the controller identifies, from the plurality of items of exercise video content, an item of exercise video content indicating a second level of exercise intensity higher than the first level of exercise intensity, and causes the item of exercise video content identified to be displayed on the display.

### Technique 4

The video control system described in any one of techniques 1 to 3, further includes: a sleep time calculator that calculates a sleep time of the user based on the information related to the level of awakening acquired, and the controller identifies an item of video content from the plurality of items of video content based on the driving information acquired, the information related to the level of awakening acquired, and the sleep time of the user calculated, and causes the item of video content identified to be displayed on the display.

### Technique 5

In the video control system described in technique 4, the video content that encourages the user to exercise includes a plurality of items of exercise video content that encourage the user to exercise at different levels of intensity, when the controller determines that the sleep time of the user calculated is greater than or equal to a predetermined threshold value, the controller identifies, from the plurality of items of exercise video content, an item of exercise video content indicating a first level of exercise intensity, and causes the item of exercise video content identified to be displayed on the display, and when the controller determines that the sleep time of the user calculated is less than the predetermined threshold value, the controller identifies, from the plurality of items of exercise video content, an item of exercise video content indicating a second level of exercise intensity higher than the first level of exercise intensity, and causes the item of exercise video content identified to be displayed on the display.

### Technique 6

In the video control system described in any one of techniques 1 to 5, the plurality of items of video content include video content in which when the user exercises, a target posture in the exercise is displayed.

### Technique 7

In the video control system described in any one of techniques 1 to 5, the plurality of items of video content include video content in which when the user exercises, a target posture in the exercise and a current posture of the user are displayed.

### Technique 8

In the video control system described in any one of techniques 1 to 5, the plurality of items of video content include video content in which when the user exercises, a target in the exercise is displayed.

### Technique 9

In the video control system described in any one of techniques 1 to 8, the controller determines, based on the driving information acquired, whether it is dangerous to cause the user to exercise, when the controller determines that it is not dangerous to cause the user to exercise, the controller continues to cause the item of video content to be displayed on the display, and when the controller determines that it is dangerous to cause the user to exercise, the controller interrupts the displaying of the item of video content on the display.

### Technique 10

A video control method is performed by a video control system, the video control system includes a display that is provided between a front seat and a rear seat in a vehicle, the video control method includes: acquiring driving information related to a driving status of the vehicle; acquiring information related to a level of awakening indicating a degree of awakening ranging from sleep to excitement of a user sitting in the rear seat; and identifying, based on the driving information acquired and the information related to the level of awakening acquired, an item of video content from a plurality of items of video content, and causing the item of video content identified to be displayed on the display, the display has optical transparency to allow the user sitting in the rear seat to visually recognize an outside of the vehicle on a side of the front seat, and the plurality of items of video content include video that encourages the user to exercise.

While various embodiments have been described herein above, it is to be appreciated that various changes in form and detail may be made without departing from the spirit and scope of the present disclosure as presently or hereafter claimed.

### Further Information About Technical Background to This Application

The disclosures of the following patent applications including specification, drawings, and claims are incorporated herein by reference in their entirety: Japanese Patent Application No. 2024-196800 filed on Nov. 11, 2024, and Japanese Patent Application No. 2025-058236 filed on Mar. 31, 2025

### Industrial Applicability

The present disclosure can be utilized, as a display control device which controls display of a display provided in a vehicle, in a rear seat entertainment (RSE) system or the like.

1. A display control device that controls display on a display provided in a vehicle, the display control device comprising:
a controller that controls display in a first display region on the display and display in a second display region on the display, the first display region being smaller than a maximum display region on the display, the second display region being different from the first display region,
wherein the controller causes a video to be displayed in the first display region, and causes a blurred video in which a part of the video is blurred to be displayed in the second display region.

2. The display control device according to claim 1,
wherein the controller causes the blurred video to be displayed in the second display region adjacent to the first display region.

3. The display control device according to claim 2,
wherein the controller causes the blurred video to be displayed in two second display regions each being the second display region, the two second display regions being located on a left side and a right side of the first display region.

4. The display control device according to claim 2,
wherein the controller causes the blurred video to be displayed in the second display region located on a left side or a right side of the first display region.

5. The display control device according to claim 1,
wherein the controller does not provide the second display region on an upper side or a lower side of the first display region.

6. The display control device according to claim 2,
wherein the controller:
generates an extended video by extending the video displayed in the first display region into the second display region; and
generates the blurred video by blurring a part of the extended video in a region that overlaps the second display region.

7. The display control device according to claim 2,
wherein the controller causes a part of the video displayed in the first display region to be blurred and displayed, the part being in an adjacent region that is adjacent to the second display region and has a predetermined width.

8. The display control device according to claim 1,
wherein the display is a translucent display that allows a rear side of the display to be seen, and
the controller causes the second display region to be translucent while causing the blurred video to be displayed in the second display region.

9. The display control device according to claim 8,
wherein the controller changes transparency of the second display region by changing at least one of contrast or brightness of the video displayed in the second display region.

10. The display control device according to claim 1,
wherein the controller causes a video to be displayed in the second display region, the video being obtained by superimposing, on the blurred video, a video depicting information detected outside the vehicle by a detection device.

11. A video display system comprising:
the display provided in the vehicle; and
the display control device according to claim 1.

12. A display control method for controlling display on a display provided in a vehicle, the display control method comprising:
when performing display in a first display region and a second region on the display, displaying a video in the first display region and a blurred video in which a part of the video is blurred in the second display region, the first display region being smaller than a maximum display region on the display, the second display region being different from the first display region.
